(19) United States
(12) Patent Application Publication
(10) Pub. No.: US 2006/0266976 A1
(43) Pub. Date: Nov. 30, 2006

(54) Compositions comprising bromofluoro-olefins and uses thereof

(76) Inventors: Barbara Haviland Minor, Elkton, MD (US); Mario Joseph Nappa, Newark, DE (US); Allen Capron Sievert, Elkton, MD (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/438,766

(22) Filed: May 23, 2006

Related U.S. Application Data
(60) Provisional application No. 60/685,287, filed on May 27, 2005.

(51) Int. Cl. C09K 5/04

(52) U.S. Cl. 252/68

(57) ABSTRACT

The present invention relates to compositions for use in refrigeration and air-conditioning systems comprising at least one bromofluoro-olefin. The present invention further relates to refrigerant and heat transfer fluid compositions comprising a flammable refrigerant and a bromofluoro-olefin. The present invention further relates to compositions for use in refrigeration apparatus and air-conditioning apparatus employing a centrifugal compressor comprising at least one bromofluoro-olefin. Further, the present invention relates to the utility of the present refrigerant and heat transfer fluid compositions in processes for producing heat and cooling, methods for reducing flammability of a refrigerant, methods for lowering GWP of a refrigerant, methods for replacing refrigerants and other uses.

### CROSS REFERENCE(S) TO RELATED APPLICATION(S)

This application claims the benefit of priority of U.S. Provisional Application No. 60/685,287, filed May 27, 2005.

### BACKGROUND OF THE INVENTION

1. Field of the Invention

The present invention relates to compositions for use in refrigeration and air-conditioning systems wherein the composition comprises at least one bromofluoro-olefin. The present invention further relates to refrigerant and heat transfer fluid compositions comprising a flammable refrigerant and a bromofluoro-olefin. The present invention further relates to compositions for use in refrigeration apparatus and air-conditioning apparatus employing a centrifugal compressor comprising at least one bromofluoro-olefin. Further, the present invention relates to the utility of the present refrigerant and heat transfer fluid compositions in processes for producing heat and cooling, methods for reducing flammability of a refrigerant, methods for lowering GWP of a refrigerant, methods for replacing refrigerants, and other uses.

2. Description of Related Art

The refrigeration industry has been working for the past few decades to find replacement refrigerants for the ozone depleting chlorofluorocarbons (CFCs) and hydrochlorofluorocarbons (HCFCs) being phased out as a result of the Montreal Protocol. The solution for most refrigerant producers has been the commercialization of hydrofluorocarbon (HFC) refrigerants. The new HFC refrigerants, HFC-134a being the most widely used at this time, have zero ozone depletion potential and thus are not affected by the current regulatory phase out as a result of the Montreal Protocol.

Further environmental regulations may ultimately cause global phase out of certain HFC refrigerants, including HFC-134a. Currently, the automobile industry is facing regulations relating to global warming potential for refrigerants used in mobile air-conditioning. Therefore, there is a great current need to identify new refrigerants with reduced global warming potential for the mobile air-conditioning market. Should the regulations be more broadly applied in the future, an even greater need will be felt for refrigerants that can be used in all areas of the refrigeration and air-conditioning industry.

Currently proposed replacement refrigerants for HFC-134a include HFC-152a, pure hydrocarbons such as butane or propane, or “natural” refrigerants such as CO₂. Many of these suggested replacements are toxic, flammable, and/or have low energy efficiency. Therefore, new alternatives are being sought.

The object of the present invention is to provide novel refrigerant compositions and heat transfer fluid compositions that possess characteristics to meet the demands of low ozone depletion potential and lower global warming potential as compared to current refrigerants.

### BRIEF SUMMARY OF THE INVENTION

The present invention relates to refrigerant or heat transfer fluid compositions comprising at least one bromofluoro-olefin selected from the group consisting of:

1-bromopentafluoropropene;

2-bromopentafluoropropene;

3-bromopentafluoropropene;

3-bromo-1,1,3,3-tetrafluoropropene;

2-bromo-1,3,3,3-tetrafluoropropene;

1-bromo-2,3,3,3-tetrafluoropropene;

3-bromo-1,1,2-trifluoropropene;

3-bromo-1,3,3-trifluoropropene;

2-bromo-3,3,3-trifluoropropene;

3-bromo-2,3,3-trifluoropropene;

2-bromo-1,3,3-trifluoropropene;

1-bromo-3,3,3-trifluoropropene;

3-bromo-3,4,4,4-tetrafluoro-1-butene;

2-bromo-4,4,4-trifluoro-2-butene;

2-bromo-1,1,1-trifluoro-2-butene;

1-bromo-3,3,3-trifluoro-2-(trifluoromethyl)-propene;

2-bromo-1 1,1,3,4,4,4-heptafluoro-2-butene;

2-bromo-3,3,4,4,4-pentafluoro-1-butene;

1-bromo-3,3,4,4,4-pentafluoro-1-butene;

2-(bromomethyl)-1,1,3,3,3-pentafluoropropene;

2-(bromodifluoromethyl)-3,3,3-trifluoropropene;

4-bromo-3,3,4,4-tetrafluoro-1-butene;

2-bromo-1,1,3,4,4,5,5,5-octafluoro-2-pentene;

2-bromo-1,1,3,4,4,5,5,5-octafluoro-1-pentene;

2-bromo-3,4,4,4-tetrafluoro-3-(trifluoromethyl)-1-butene;

1-bromo-2,3,3,4,4,5,5-heptafluoro-1-pentene;

2-bromo-3,3,4,4,5,5,5-heptafluoro-1-pentene;

1-bromo-4,4,4-trifluoro-3-(trifluoromethyl)-1-butene;

4-bromo-1,1,1-trifluoro-2-(trifluoromethyl)-2-butene;

3-(bromodifluoromethyl)-3,4,4,4-tetrafluoro-1-butene;

5-bromo-1,1,3,3,5,5-hexafluoro-1-pentene; and

3-bromo-1,1,1,2,4,4,5,5,5-nonafluoro-2-pentene.

Further, the present invention relates to refrigerant and heat transfer fluid compositions comprising a flammable refrigerant and a bromofluoro-olefin.

Further, the present invention relates to use of the present refrigerant and heat transfer fluid compositions in processes for producing heat and cooling, methods for reducing flammability of a refrigerant, methods for lowering GWP of a refrigerant, methods for replacing refrigerants and other uses.

### DETAILED DESCRIPTION OF THE INVENTION

The present invention relates to bromofluoro-olefins that are useful as refrigerants and heat transfer fluids.

The bromofluoro-olefins of the present invention are unsaturated carbon compounds with at least one bromine, at least one fluorine. Some of these compounds include at least one hydrogen atom in the structure. These compounds may be 3, 4 or 5 carbons in length and possess at least one double bond. The bromofluoro-olefins of the present invention are listed in Table 1.

TABLE 1

| Chemical Name | Chemical Formula |
|---|---|
| 1-Bromopentafluoropropene | CFBr═CFCF₃ |
| 2-Bromopentafluoropropene | CF₂═CBrCF₃ |
| 3-Bromopentafluoropropene | CF₂═CFCF₂Br |
| 3-Bromo-1,1,3,3-tetrafluoropropene | CF₂═CHCF₂Br |
| 2-Bromo-1,3,3,3-tetrafluoropropene | CFH═CBrCF₃ |
| 1-Bromo-2,3,3,3-tetrafluoropropene | CHBr═CFCF₃ |
| 3-Bromo-1,1,2-trifluoropropene | CF₂═CFCBrH₂ |
| 3-Bromo-1,3,3-trifluoropropene | CFH═CHCBrF₂ |
| 2-Bromo-3,3,3-trifluoropropene | CH₂═CBrCF₃ |
| 3-Bromo-2,3,3-trifluoropropene | CH₂═CFCBrF₂ |
| 2-Bromo-1,3,3-trifluoropropene | CHF═CBrCHF₂ |
| 1-Bromo-3,3,3-trifluoropropene | CHBr═CHCF₃ |
| 2-Bromo-1,1,1,3,4,4,4-heptafluoro-2-butene | CF₃CBr═CFCF₃ |
| 2-Bromo-3,3,4,4,4-pentafluoro-1-butene | CH₂═CBrCF₂CF₃ |
| 1-Bromo-3,3,4,4,4-pentafluoro-1-butene | CHBr═CHCF₂CF₃ |
| 4-Bromo-3,3,4,4-tetrafluoro-1-butene (BTFB) | CH₂═CHCF₂CF₂Br |
| 3-Bromo-3,4,4,4-tetrafluoro-1-butene | CH₂═CHCBrFCF₃ |
| 2-Bromo-4,4,4-trifluoro-2-butene | CH₃CBr═CHCF₃ |
| 2-Bromo-1,1,1-trifluoro-2-butene | CF₃CBr═CHCH₃ |
| 1-Bromo-3,3,3-trifluoro-2- | (CF₃)₂C═CHBr |
| (trifluoromethyl)-propene | |
| 3-bromo-1,1,1,2,4,4,5,5,5-nonafluoro-2- | CF₃CF═CBrCF₂CF₃ |
| pentene | |
| 2-Bromo-1,1,3,4,4,5,5,5-octafluoro-2-pentene | CHF₂CBr═CFC₂F₅ |
| 2-Bromo-1,1,3,4,4,5,5,5-octafluoro-1-pentene | CF₂═CBrCHFC₂F₅ |
| 2-Bromo-3,4,4,4-tetrafluoro-3- | (CF₃)₂CFCBr═CH₂ |
| (trifluoromethyl)-1-butene | |
| 1-Bromo-2,3,3,4,4,5,5-heptafluoro-1-pentene | CHBr═CF(CF₂)₂CHF₂ |
| 2-Bromo-3,3,4,4,5,5,5-heptafluoro-1-pentene | CH₂═CBrCF₂C₂F₅ |
| 2-(Bromomethyl)-1,1,3,3,3-pentafluoropropene | CF₂═C(CH₂Br)CF₃ |
| 2-(Bromodifluoromethyl)-3,3,3- | CH₂═C(CBrF₂)CF₃ |
| trifluoropropene | |
| 1-Bromo-4,4,4-trifluoro-3-(trifluoromethyl)- | (CF₃)₂CHCH═CHBr |
| 1-butene | |
| 4-Bromo-1,1,1-trifluoro-2-(trifluoromethyl)- | (CF₃)₂C═CHCH₂Br |
| 2-butene | |
| 3-(Bromodifluoromethyl)-3,4,4,4-tetrafluoro- | CH₂═CHCF(CF₃)CBrF₂ |
| 1-butene | |
| 5-Bromo-1,1,3,3,5,5-hexafluoro-1-pentene | CF₂═CHCF₂CH₂CBrF₂ |

The bromofluoro-olefins listed in Table 1 are available from commercial sources or may be prepared by methods known in the art. For example, 2-bromo-1,3,3,3-tetrafluoropropene may be prepared by bromination of 1,3,3,3-tetrafluoropropene to give 2,3-dibromo-1,1,1,3-tetrafluoropropane followed by reaction with potassium hydroxide. 2-Bromo-3,3,4,4,4-pentafluoro-1-butene may be prepared by bromination of pentafluoroethylethylene to give 3,4-dibromo-1,1,1,2,2-pentafluorobutane followed by reaction with potassium hydroxide. 1-Bromo-3,3,4,4,4-pentafluoro-1-butene may be prepared by reaction of hydrogen bromide with 3,3,4,4,4-pentafluoro-1-butyne. 2-Bromo-1,1,1-trifluoro-2-butene may be prepared by addition of bromine to 1,1,1-trifluoro-2-butene followed by reaction with potassium hydroxide. 3-Bromo-1,1,1,2,4,4,5,5,5-nonafluoro-2-pentene may be prepared by reaction of 3,3-dibromo-1,1,1,2,2,4,4,5,5,5-decafluoropentane with iron. 2-Bromo-3,4,4,4-tetrafluoro-3-(trifluoromethyl)-1-butene may be prepared by bromination of heptafluoroisopropyl ethylene to give 3,4-dibromo-1,1,1,2-tetrafluoro-2-(trifluoromethyl)butane followed by reaction with potassium hydroxide.

In one embodiment, the compositions of the present invention may comprise a single compound as listed in Table 1 or may comprise a combination of compounds from Table 1. Additionally, many of the compounds in Table 1 may exist as different configurational isomers or stereoisomers. The present invention is intended to include all single configurational isomers, single stereoisomers or any combination thereof. For instance, 2-bromo-1,3,3-trifluoropropene is meant to represent the E-isomer, Z-isomer, or any combination or mixture of both isomers in any ratio. Another example is 2-bromo-1,1,3,4,4,5,5,5-octafluoro-2-pentene, by which is represented the E-isomer, Z-isomer, or any combination or mixture of both isomers in any ratio.

Bromofluoro-olefins of the present invention that are useful as refrigerants are any of the following;

1-bromopentafluoropropene;

2-bromopentafluoropropene;

3-bromopentafluoropropene;

3-bromo-1,1,3,3-tetrafluoropropene;

2-bromo-1,3,3,3-tetrafluoropropene;

1-bromo-2,3,3,3-tetrafluoropropene;

3-bromo-1,1,2-trifluoropropene;

3-bromo-1,3,3-trifluoropropene;

2-bromo-3,3,3-trifluoropropene;

3-bromo-2,3,3-trifluoropropene;

2-bromo-1,3,3-trifluoropropene;

1-bromo-3,3,3-trifluoropropene;

3-bromo-3,4,4,4-tetrafluoro-1-butene;

2-bromo-4,4,4-trifluoro-2-butene;

2-bromo-1,1,1-trifluoro-2-butene;

1-bromo-3,3,3-trifluoro-2-(trifluoromethyl)-propene;

2-bromo-1,1,1,3,4,4,4-heptafluoro-2-butene;

2-bromo-3,3,4,4,4-pentafluoro-1-butene;

1-bromo-3,3,4,4,4,-pentafluoro-1-butene;

2-(bromomethyl)-1,1,3,3,3-pentafluoropropene;

2-(bromodifluoromethyl)-3,3,3-trifluoropropene;

4-bromo-3,3,4,4-tetrafluoro-1-butene;

2-bromo-1,1,3,4,4,5,5,5-octafluoro-2-pentene;

2-bromo-1,1,3,4,4,5,5,5-octafluoro-1-pentene;
2-bromo-3,4,4,4-tetrafluoro-3-(trifluoromethyl)-1-butene;

1-bromo-2,3,3,4,4,5,5-heptafluoro-1-pentene;

2-bromo-3,3,4,4,5,5,5-heptafluoro-1-pentene;

1-bromo-4,4,4-trifluoro-3-(trifluoromethyl)-1-butene;

4-bromo-1,1,1-trifluoro-2-(trifluoromethyl)-2-butene;

3-(bromodifluoromethyl)-3,4,4,4-tetrafluoro-1-butene;

5-bromo-1,1,3,3,5,5-hexafluoro-1-pentene;

3-bromo-1,1,1,2,4,4,5,5,5-nonafluoro-2-pentene;

and combinations thereof.

Bromofluoro-olefins of the present invention have low or zero ozone depletion potential and low global warming potential as compared to many HFC refrigerants currently in use.

In another embodiment, the present invention relates to compositions comprising at least one bromofluoro-olefin and at least one flammable refrigerant or heat transfer fluid, wherein the bromofluoro-olefin is selected from the group consisting of:

1-bromopentafluoropropene;

2-bromopentafluoropropene;

3-bromopentafluoropropene;

3-bromo-1,1,3,3-tetrafluoropropene;

2-bromo-1,3,3,3-tetrafluoropropene;

1-bromo-2,3,3,3-tetrafluoropropene;

3-bromo-1,1,2-trifluoropropene;

3-bromo-1,3,3-trifluoropropene;

2-bromo-3,3,3-trifluoropropene;

3-bromo-2,3,3-trifluoropropene;

2-bromo-1, 3,3-trifluoropropene;

1-bromo-3, 3,3-trifluoropropene;

3-bromo-3,4,4,4-tetrafluoro-1-butene;

2-bromo-4,4,4-trifluoro-2-butene;

2-bromo-1,1,1-trifluoro-2-butene;

1-bromo-3,3,3-trifluoro-2-(trifluoromethyl)-propene;

2-bromo-1,1,1,3,4,4,4-heptafluoro-2-butene;

2-bromo-3,3,4,4,4-pentafluoro-1-butene;

1-bromo-3, 3,4,4,4,-pentafluoro-1-butene;

2-(bromomethyl)-1,1,3,3,3-pentafluoropropene;

2-(bromodifluoromethyl)-3,3,3-trifluoropropene;

4-bromo-3,3,4,4-tetrafluoro-1-butene;

2-bromo-1,1,3,4,4,5,5,5-octafluoro-2-pentene;

2-bromo-1,1,3,4,4,5,5,5-octafluoro-1-pentene;

2-bromo-3,4,4,4-tetrafluoro-3-(trifluoromethyl)-1-butene;

1-bromo-2,3,3,4,4,5,5-heptafluoro-1-pentene;

2-bromo-3,3,4,4,5,5,5-heptafluoro-1-pentene;

1-bromo-4,4,4-trifluoro-3-(trifluoromethyl)-1-butene;

4-bromo-1,1,1-trifluoro-2-(trifluoromethyl)-2-butene;

3-(bromodifluoromethyl)-3,4,4,4-tetrafluoro-1-butene;

5-bromo-1,1,3,3,5,5-hexafluoro-1-pentene;

3-bromo-1,1,1,2,4,4,5,5,5-nonafluoro-2-pentene.

Flammable refrigerants of the present invention include fluoroethers, hydrocarbon ethers, and combinations thereof. Flammable refrigerants of the present invention comprise any compound which may be demonstrated to propagate a flame under specified conditions of temperature, pressure and composition when mixed with air. Flammable refrigerants may be identified by testing under conditions specified by ASHRAE (American Society of Heating, Refrigerating and Air-Conditioning Engineers, Inc.) Standard 34-2001, under ASTM (American Society of Testing and Materials) E681-01, with an electronic ignition source. Such tests of flammability are conducted with the refrigerant at 101 kPa (14.7 psia) and 100° C. (212° F.) at various concentrations in air in order to determine the lower flammability limit (LFL) and upper flammability limit (UFL) of the test compound in air.

In practical terms, a refrigerant may be classified as flammable if upon leaking from a refrigeration apparatus or air-conditioning apparatus, and contacting an ignition source a fire may result. The compositions of the present invention, during such a leak, have a low probability of causing a fire.

Flammable refrigerants of the present invention further comprise fluoroethers, compounds similar to hydrofluorocarbons, which also contain at least one ether group oxygen atom. Representative fluoroether refrigerants includes but are not limited to C₄F₉OC₂H₅ (available from 3M™, St. Paul, Minn.).

Flammable refrigerants of the present invention further comprise hydrocarbon ethers, such as dimethyl ether (DME) sold by E.I. du Pont de Nemours and Company, Wilmington, Del.

Flammable refrigerants of the present invention may further comprise mixtures of more than one refrigerant such as a mixture of two or more flammable refrigerants (eg. two HFCs or an HFC and a hydrocarbon) or a mixture comprising a flammable refrigerant and a non-flammable refrigerant, such that the overall mixture is a flammable refrigerant, identified under the ASHRAE test conditions described herein, or in practical terms.

Examples of non-flammable refrigerants that may be combined with other refrigerants of the present invention include R-134a, R-23, R125, R-236fa, R-245fa, and non-flammable mixtures of HCFC-22/HFC-152a/HCFC-124 (known by the ASHRAE designations, R-401), HFC-125/HFC-143a/HFC-134a (known by the ASHRAE designation, R404), HFC-32/HFC-125/HFC-134a (known by ASHRAE designations, R407), HCFC-22/HFC-143a/HFC-125 (known by the ASHRAE designation, R-408), HCFC-22/HCFC-1 24/HCFC-142b (known by the ASHRAE designation: R409), HFC-32/HFC-125 (known by the ASHRAE designation R-410), and HFC-125/HFC-143a (known by the ASHRAE designation: R-507) and carbon dioxide.

Examples of mixtures of more than one flammable refrigerant include propane/isobutane; HFC-152a/isobutane, R32/propane; R32/isobutane; and HFC/carbon dioxide mixtures such as HFC-152a/CO₂.

It has been demonstrated that while certain refrigerants are flammable, it is possible to produce a non-flammable refrigerant composition by adding to the flammable refrigerant another compound that is not flammable. Examples of such nonflammable refrigerant blends include R-410A (HFC-32 is a flammable refrigerant, while HFC-125 is not flammable), and R-407C (HFC-32 is a flammable refrigerant, while HFC-125 and HFC-134a are not flammable).

The compositions of the present invention comprising at least one bromofluoro-olefin and at least one flammable refrigerant may contain an effective amount of bromofluoro-olefin to produce a composition that is not flammable based upon results of ASTM E681-01.

In one embodiment, the present inventive compositions comprising at least one flammable refrigerant and at least one bromofluoro-olefin may contain about 1 weight percent to about 99 weight percent bromofluoro-olefin and about 99 weight percent to about 1 weight percent flammable refrigerant.

Alternatively, the compositions of the present invention may contain about 10 weight percent to about 80 weight percent bromofluoro-olefin and about 90 weight percent to about 20 weight percent flammable refrigerant. Yet again, the compositions of the present invention may contain about 20 weight percent to about 70 weight percent bromofluoro-olefin and about 80 weight percent to about 30 weight percent flammable refrigerant.

In another embodiment, the present invention relates to a method for reducing the flammability of a flammable refrigerant said method comprising combining the flammable refrigerant with at least one bromofluoro-olefin.

The compositions of the present invention that are combinations or mixtures may be prepared by any convenient method to combine the desired amounts of the individual components. A preferred method is to weigh the desired component amounts and thereafter combine the components in an appropriate vessel. Agitation may be used, if desired.

In another embodiment of the invention, the compositions further comprise a lubricant. Lubricants of the present invention comprise those suitable for use with refrigeration or air-conditioning apparatus. Among these lubricants are those conventionally used in compression refrigeration apparatus utilizing chlorofluorocarbon refrigerants. Such lubricants and their properties are discussed in the 1990 ASHRAE Handbook, Refrigeration Systems and Applications, chapter 8, titled “Lubricants in Refrigeration Systems”, pages 8.1 through 8.21, herein incorporated by reference. Lubricants of the present invention may comprise those commonly known as “mineral oils” in the field of compression refrigeration lubrication. Mineral oils comprise paraffins (i.e. straight-chain and branched-carbon-chain, saturated hydrocarbons), naphthenes (i.e. cyclic paraffins) and aromatics (i.e. unsaturated, cyclic hydrocarbons containing one or more rings characterized by alternating double bonds). Lubricants of the present invention further comprise those commonly known as “synthetic oils” in the field of compression refrigeration lubrication. Synthetic oils comprise alkylaryls (i.e. linear and branched alkylbenzenes), synthetic paraffins and napthenes, and poly(alphaolefins). Representative conventional lubricants of the present invention are the commercially available BVM 100 N (paraffinic mineral oil sold by BVA Oils), Suniso® 3GS and Suniso® 5GS (napthenic mineral oil sold by Crompton Co.), Sontex® 372LT (napthenic mineral oil sold by Pennzoil), Calumet® RO-30 (napthenic mineral oil sold by Calument Lubricants), Zerol® 75, Zerol® 150 and Zerol® 500 (linear alkylbenzenes sold by Shrieve Chemicals) and HAB 22 (branched alkylbenzene sold by Nippon Oil).

Lubricants of the present invention further comprise those which have been designed for use with hydrofluorocarbon refrigerants and are miscible with refrigerants of the present invention under compression refrigeration and air-conditioning apparatus' operating conditions. Such lubricants and their properties are discussed in “Synthetic Lubricants and High-Performance Fluids”, R. L. Shubkin, editor, Marcel Dekker, 1993. Such lubricants include, but are not limited to, polyol esters (POEs) such as Castrol® 100 (Castrol, United Kingdom), polyalkylene glycols (PAGs) such as RL-488A from Dow (Dow Chemical, Midland, Mich.), and polyvinyl ethers (PVEs).

Lubricants of the present invention are selected by considering a given compressor's requirements and the environment to which the lubricant will be exposed. Lubricants of the present invention preferably have a kinematic viscosity of at least about 5 cs (centistokes) at 40° C.

Commonly used refrigeration system additives may optionally be added, as desired, to compositions of the present invention in order to enhance lubricity and system stability. These additives are generally known within the field of refrigeration compressor lubrication, and include anti wear agents, extreme pressure lubricants, corrosion and oxidation inhibitors, metal surface deactivators, foaming and antifoam control agents, leak detectants and the like. In general, these additives are present only in small amounts relative to the overall lubricant composition. They are typically used at concentrations of from less than about 0.01% to as much as about 5% of each additive. These additives are selected on the basis of the individual system requirements. Some typical examples of such additives may include, but are not limited to, lubrication enhancing additives, such as alkyl or aryl esters of phosphoric acid and of thiophosphates. Additionally, the metal dialkyl dithiophosphates (e.g. zinc dialkyl dithiophosphate or ZDDP, Lubrizol 1375) and other members of this family of chemicals may be used in compositions of the present invention. Other antiwear additives include natural product oils and assymetrical polyhydroxyl lubrication additives such as Synergol TMS (International Lubricants). Similarly, stabilizers such as antioxidants, free radical scavengers, and water scavengers (drying compounds) may be employed. Such additives include but are not, limited to, nitromethane, hindered phenols (such as butylated hydroxy toluene, or BHT), hydroxylamines, thiols, phosphites, epoxides or lactones. Water scavengers include but are not limited to ortho esters such as trimethyl-, triethyl-, or tripropylortho formate. Single additives or combinations may be used.

In yet another embodiment, the compositions of the present invention may further comprise an ultra-violet (UV) dye and optionally a solubilizing agent. The UV dye is a useful component for detecting leaks of the refrigerant composition or heat transfer fluids by permitting one to observe the fluorescence of the dye in the refrigerant or heat transfer fluid composition at a leak point or in the vicinity of refrigeration or air-conditioning apparatus. One may observe the fluorescence of the dye under an ultra-violet light. Solubilizing agents may be needed due to poor solubility of such UV dyes in some refrigerants and heat transfer fluids.

By “ultra-violet” dye is meant a UV fluorescent composition that absorbs light in the ultra-violet or “near” ultra-violet region of the electromagnetic spectrum. The fluorescence produced by the UV fluorescent dye under illumination by a UV light that emits radiation with wavelength anywhere from 10 nanometers to 750 nanometers may be detected. Therefore, if refrigerant or heat transfer fluid containing such a UV fluorescent dye is leaking from a given point in a refrigeration or air-conditioning apparatus, the fluorescence can be detected at the leak point. Such UV fluorescent dyes include but are not limited to naphthalimides, perylenes, coumarins, anthracenes, phenanthracenes, xanthenes, thioxanthenes, naphthoxanthenes, fluoresceins, and derivatives of said dye or combinations thereof. Solubilizing agents of the present invention comprise at least one compound selected from the group consisting of hydrocarbons, hydrocarbon ethers, polyoxyalkylene glycol ethers, amides, nitriles, ketones, chlorocarbons, esters, lactones, aryl ethers, fluoroethers and 1,1,1-trifluoroalkanes.

Hydrocarbon solubilizing agents of the present invention comprise hydrocarbons including straight chain, branched chain or cyclic alkanes or alkenes containing 16 or fewer carbon atoms and only hydrogen with no other functional groups. Representative hydrocarbon solubilizing agents comprise propane, propylene, cyclopropane, n-butane, isobutane, n-pentane, octane, decane, and hexadecane. It should be noted that if the refrigerant is a hydrocarbon, then the solubilizing agent may not be the same hydrocarbon.

Hydrocarbon ether solubilizing agents of the present invention comprise ethers containing only carbon, hydrogen and oxygen, such as dimethyl ether (DME).

Polyoxyalkylene glycol ether solubilizing agents of the present invention are represented by the formula R¹[(OR²)ₓOR³]_{y}, wherein: x is an integer from 1-3; y is an integer from 1-4; R¹ is selected from hydrogen and aliphatic hydrocarbon radicals having 1 to 6 carbon atoms and y bonding sites; R² is selected from aliphatic hydrocarbylene radicals having from 2 to 4 carbon atoms; R³ is selected from hydrogen and aliphatic and alicyclic hydrocarbon radicals having from 1 to 6 carbon atoms; at least one of R¹ and R³ is said hydrocarbon radical; and wherein said polyoxyalkylene glycol ethers have a molecular weight of from about 100 to about 300 atomic mass units. As used herein, bonding sites mean radical sites available to form covalent bonds with other radicals. Hydrocarbylene radicals mean divalent hydrocarbon radicals. In the present invention, preferred polyoxyalkylene glycol ether solubilizing agents are represented by R¹[(OR²)ₓOR³]_{y}: x is preferably 1-2; y is preferably 1; R¹ and R³ are preferably independently selected from hydrogen and aliphatic hydrocarbon radicals having 1 to 4 carbon atoms; R² is preferably selected from aliphatic hydrocarbylene radicals having from 2 or 3 carbon atoms, most preferably 3 carbon atoms; the polyoxyalkylene glycol ether molecular weight is preferably from about 100 to about 250 atomic mass units, most preferably from about 125 to about 250 atomic mass units. The R¹ and R³ hydrocarbon radicals having 1 to 6 carbon atoms may be linear, branched or cyclic. Representative R¹ and R³ hydrocarbon radicals include methyl, ethyl, propyl, isopropyl, butyl, isobutyl, sec-butyl, tert-butyl, pentyl, isopentyl, neopentyl, tert-pentyl, cyclopentyl, and cyclohexyl. Where free hydroxyl radicals on the present polyoxyalkylene glycol ether solubilizing agents may be incompatible with certain compression refrigeration apparatus materials of construction (e.g. Mylar®), R¹ and R³ are preferably aliphatic hydrocarbon radicals having 1 to 4 carbon atoms, most preferably 1 carbon atom. The R² aliphatic hydrocarbylene radicals having from 2 to 4 carbon atoms form repeating oxyalkylene radicals —(OR²)ₓ— that include oxyethylene radicals, oxypropylene radicals, and oxybutylene radicals. The oxyalkylene radical comprising R² in one polyoxyalkylene glycol ether solubilizing agent molecule may be the same, or one molecule may contain different R² oxyalkylene groups. The present polyoxyalkylene glycol ether solubilizing agents preferably comprise at least one oxypropylene radical. Where R¹ is an aliphatic or alicyclic hydrocarbon radical having 1 to 6 carbon atoms and y bonding sites, the radical may be linear, branched or cyclic. Representative R¹ aliphatic hydrocarbon radicals having two bonding sites include, for example, an ethylene radical, a propylene radical, a butylene radical, a pentylene radical, a hexylene radical, a cyclopentylene radical and a cyclohexylene radical. Representative R¹ aliphatic hydrocarbon radicals having three or four bonding sites include residues derived from polyalcohols, such as trimethylolpropane, glycerin, pentaerythritol, 1,2,3-trihydroxycyclohexane and 1,3,5-trihydroxycyclohexane, by removing their hydroxyl radicals.

Representative polyoxyalkylene glycol ether solubilizing agents include but are not limited to: CH₃OCH₂CH(CH₃)O(H or CH₃) (propylene glycol methyl (or dimethyl) ether), CH₃O[CH₂CH(CH₃)O]₂(H or CH₃) (dipropylene glycol methyl (or dimethyl) ether), CH₃O[CH₂CH(CH₃)O]₃(H or CH₃) (tripropylene glycol methyl (or dimethyl) ether), C₂H₅OCH₂CH(CH₃)O(H or C₂H₅) (propylene glycol ethyl (or diethyl) ether), C₂H₅O[CH₂CH(CH₃)O]₂(H or C₂H₅) (dipropylene glycol ethyl (or diethyl) ether), C₂H₅O[CH₂CH(CH₃)O]₃(H or C₂H₅) (tripropylene glycol ethyl (or diethyl) ether), C₃H₇OCH₂CH(CH₃)O(H or C₃H₇) (propylene glycol n-propyl (or di-n-propyl) ether), C₃H₇O[CH₂CH(CH₃)O]₂(H or C₃H₇) (dipropylene glycol n-propyl (or di-n-propyl) ether) , C₃H₇O[CH₂CH(CH₃)O]₃(H or C₃H₇) (tripropylene glycol n-propyl (or di-n-propyl) ether), C₄H₉OCH₂CH(CH₃)OH (propylene glycol n-butyl ether), C₄H₉O[CH₂CH(CH₃)O]₂(H or C₄H₉) (dipropylene glycol n-butyl (or di-n-butyl) ether), C₄H₉O[CH₂CH(CH₃)O]₃(H or C₄H₉) (tripropylene glycol n-butyl (or di-n-butyl) ether), (CH₃)₃COCH₂CH(CH₃)OH (propylene glycol t-butyl ether), (CH₃)₃CO[CH₂CH(CH₃)O]₂(H or (CH₃)₃) (dipropylene glycol t-butyl (or di-t-butyl)ether), (CH₃)₃CO[CH₂CH(CH₃)O]₃(H or (CH₃)₃) (tripropylene glycol t-butyl (or di-t-butyl) ether), C₅H₁₁OCH₂CH(CH₃)OH (propylene glycol n-pentyl ether), C₄H₉OCH₂CH(C₂H₅)OH (butylene glycol n-butyl ether), C₄H₉O[CH₂CH(C₂H₅)O]₂H (dibutylene glycol n-butyl ether), trimethylolpropane tri-n-butyl ether (C₂H₅C(CH₂O(CH₂)₃CH₃)₃) and trimethylolpropane di-n-butyl ether (C₂H₅C(CH₂OC(CH₂)₃CH₃)₂CH₂OH).

Amide solubilizing agents of the present invention comprise those represented by the formulae R¹C(O)NR²R³ and cyclo-[R⁴C(O)N(R⁵)], wherein R¹, R², R³ and R⁵ are independently selected from aliphatic and alicyclic hydrocarbon radicals having from 1 to 12 carbon atoms; R⁴ is selected from aliphatic hydrocarbylene radicals having from 3 to 12 carbon atoms; and wherein said amides have a molecular weight of from about 100 to about 300 atomic mass units. The molecular weight of said amides is preferably from about 160 to about 250 atomic mass units. R¹, R², R³ and R⁵ may optionally include substituted hydrocarbon radicals, that is, radicals containing non-hydrocarbon substituents selected from halogens (e.g., fluorine, chlorine) and alkoxides (e.g. methoxy). R¹, R², R³ and R⁵ may optionally include heteroatom-substituted hydrocarbon radicals, that is, radicals, which contain the atoms nitrogen (aza-), oxygen (oxa-) or sulfur (thia-) in a radical chain otherwise composed of carbon atoms. In general, no more than three non-hydrocarbon substituents and heteroatoms, and preferably no more than one, will be present for each 10 carbon atoms in R¹⁻³, and the presence of any such non-hydrocarbon substituents and heteroatoms must be considered in applying the aforementioned molecular weight limitations. Preferred amide solubilizing agents consist of carbon, hydrogen, nitrogen and oxygen. Representative R¹, R², R³ and R⁵aliphatic and alicyclic hydrocarbon radicals include methyl, ethyl, propyl, isopropyl, butyl, isobutyl, sec-butyl, tert-butyl, pentyl, isopentyl, neopentyl, tert-pentyl, cyclopentyl, cyclohexyl, heptyl, octyl, nonyl, decyl, undecyl, dodecyl and their configurational isomers. A preferred embodiment of amide solubilizing agents are those wherein R⁴ in the aforementioned formula cyclo-[R⁴C(O)N(R⁵)—] may be represented by the hydrocarbylene radical (CR⁶R⁷)ₙ, in other words, the formula: cyclo-[(CR⁶R⁷)ₙC(O)N(R⁵)—] wherein: the previously-stated values for molecular weight apply; n is an integer from 3 to 5; R⁵ is a saturated hydrocarbon radical containing 1 to 12 carbon atoms; R⁶ and R⁷are independently selected (for each n) by the rules previously offered defining R¹⁻³. In the lactams represented by the formula: cyclo-[(CR⁶R⁷)ₙC(O)N(R⁵)—], all R⁶ and R⁷ are preferably hydrogen, or contain a single saturated hydrocarbon radical among the n methylene units, and R⁵ is a saturated hydrocarbon radical containing 3 to 12 carbon atoms. For example, 1-(saturated hydrocarbon radical)-5-methylpyrrolidin-2-ones.

Representative amide solubilizing agents include but are not limited to: 1-octylpyrrolidin-2-one, 1-decylpyrrolidin-2-one, 1-octyl-5-methylpyrrolidin-2-one, 1-butylcaprolactam, 1-cyclohexylpyrrolidin-2-one, 1-butyl-5-methylpiperid-2-one, 1-pentyl-5-methylpiperid-2-one, 1-hexylcaprolactam, 1-hexyl-5-methylpyrrolidin-2-one, 5-methyl-1-pentylpiperid-2-one, 1,3-dimethylpiperid-2-one, 1-methylcaprolactam, 1-butyl-pyrrolidin-2-one, 1,5-dimethylpiperid-2-one, 1-decyl-5-methylpyrrolidin-2-one, 1-dodecylpyrrolid-2-one, N,N-dibutylformamide and N,N-diisopropylacetamide.

Ketone solubilizing agents of the present invention comprise ketones represented by the formula R¹C(O)R², wherein R¹ and R² are independently selected from aliphatic, alicyclic and aryl hydrocarbon radicals having from 1 to 12 carbon atoms, and wherein said ketones have a molecular weight of from about 70 to about 300 atomic mass units. R¹ and R² in said ketones are preferably independently selected from aliphatic and alicyclic hydrocarbon radicals having 1 to 9 carbon atoms. The molecular weight of said ketones is preferably from about 100 to 200 atomic mass units. R¹ and R² may together form a hydrocarbylene radical connected and forming a five, six, or seven-membered ring cyclic ketone, for example, cyclopentanone, cyclohexanone, and cycloheptanone. R¹ and R² may optionally include substituted hydrocarbon radicals, that is, radicals containing non-hydrocarbon substituents selected from halogens (e.g., fluorine, chlorine) and alkoxides (e.g. methoxy). R¹ and R² may optionally include heteroatom-substituted hydrocarbon radicals, that is, radicals, which contain the atoms nitrogen (aza-), oxygen (keto-, oxa-) or sulfur (thia-) in a radical chain otherwise composed of carbon atoms. In general, no more than three non-hydrocarbon substituents and heteroatoms, and preferably no more than one, will be present for each 10 carbon atoms in R¹ and R², and the presence of any such non-hydrocarbon substituents and heteroatoms must be considered in applying the aforementioned molecular weight limitations. Representative R¹ and R² aliphatic, alicyclic and aryl hydrocarbon radicals in the general formula R¹C(O)R² include methyl, ethyl, propyl, isopropyl, butyl, isobutyl, sec-butyl, tert-butyl, pentyl, isopentyl, neopentyl, tert-pentyl, cyclopentyl, cyclohexyl, heptyl, octyl, nonyl, decyl, undecyl, dodecyl and their configurational isomers, as well as phenyl, benzyl, cumenyl, mesityl, tolyl, xylyl and phenethyl.

Representative ketone solubilizing agents include but are not limited to: 2-butanone, 2-pentanone, acetophenone, butyrophenone, hexanophenone, cyclohexanone, cycloheptanone, 2-heptanone, 3-heptanone, 5-methyl-2-hexanone, 2-octanone, 3-octanone, diisobutyl ketone, 4-ethylcyclohexanone, 2-nonanone, 5-nonanone, 2-decanone, 4-decanone, 2-decalone, 2-tridecanone, dihexyl ketone and dicyclohexyl ketone.

Nitrile solubilizing agents of the present invention comprise nitriles represented by the formula R¹CN, wherein R¹ is selected from aliphatic, alicyclic or aryl hydrocarbon radicals having from 5 to 12 carbon atoms, and wherein said nitriles have a molecular weight of from about 90 to about 200 atomic mass units. R¹ in said nitrile solubilizing agents is preferably selected from aliphatic and alicyclic hydrocarbon radicals having 8 to 10 carbon atoms. The molecular weight of said nitrile solubilizing agents is preferably from about 120 to about 140 atomic mass units. R¹ may optionally include substituted hydrocarbon radicals, that is, radicals containing non-hydrocarbon substituents selected from halogens (e.g., fluorine, chlorine) and alkoxides (e.g. methoxy). R¹ may optionally include heteroatom-substituted hydrocarbon radicals, that is, radicals, which contain the atoms nitrogen (aza-), oxygen (keto-, oxa-) or sulfur (thia-) in a radical chain otherwise composed of carbon atoms. In general, no more than three non-hydrocarbon substituents and heteroatoms, and preferably no more than one, will be present for each 10 carbon atoms in R¹, and the presence of any such non-hydrocarbon substituents and heteroatoms must be considered in applying the aforementioned molecular weight limitations. Representative R¹ aliphatic, alicyclic and aryl hydrocarbon radicals in the general formula R¹CN include pentyl, isopentyl, neopentyl, tert-pentyl, cyclopentyl, cyclohexyl, heptyl, octyl, nonyl, decyl, undecyl, dodecyl and their configurational isomers, as well as phenyl, benzyl, cumenyl, mesityl, tolyl, xylyl and phenethyl. Representative nitrile solubilizing agents include but are not limited to: 1-cyanopentane, 2,2-dimethyl-4-cyanopentane, 1-cyanohexane, 1-cyanoheptane, 1-cyanooctane, 2-cyanooctane, 1-cyanononane, 1-cyanodecane, 2-cyanodecane, 1-cyanoundecane and 1-cyanododecane.

Chlorocarbon solubilizing agents of the present invention comprise chlorocarbons represented by the formula RClₓ, wherein; x is selected from the integers 1 or 2; R is selected from aliphatic and alicyclic hydrocarbon radicals having 1 to 12 carbon atoms; and wherein said chlorocarbons have a molecular weight of from about 100 to about 200 atomic mass units. The molecular weight of said chlorocarbon solubilizing agents is preferably from about 120 to 150 atomic mass units. Representative R aliphatic and alicyclic hydrocarbon radicals in the general formula RClₓ include methyl, ethyl, propyl, isopropyl, butyl, isobutyl, sec-butyl, tert-butyl, pentyl, isopentyl, neopentyl, tert-pentyl, cyclopentyl, cyclohexyl, heptyl, octyl, nonyl, decyl, undecyl, dodecyl and their configurational isomers.

Representative chlorocarbon solubilizing agents include but are not limited to: 3-(chloromethyl)pentane, 3-chloro-3-methylpentane, 1-chlorohexane, 1,6-dichlorohexane, 1-chloroheptane, 1-chlorooctane, 1-chlorononane, 1-chlorodecane, and 1,1,1-trichlorodecane.

Ester solubilizing agents of the present invention comprise esters represented by the general formula R¹CO₂R², wherein R¹ and R² are independently selected from linear and cyclic, saturated and unsaturated, alkyl and aryl radicals. Preferred esters consist essentially of the elements C, H and O, have a molecular weight of from about 80 to about 550 atomic mass units.

Representative esters include but are not limited to: (CH₃)₂CHCH₂OOC(CH₂)₂₋₄OCOCH₂CH(CH₃)₂ (diisobutyl dibasic ester), ethyl hexanoate, ethyl heptanoate, n-butyl propionate, n-propyl propionate, ethyl benzoate, di-n-propyl phthalate, benzoic acid ethoxyethyl ester, dipropyl carbonate, “Exxate 700” (a commercial C₇ alkyl acetate), “Exxate 800” (a commercial C₈ alkyl acetate), dibutyl phthalate, and tert-butyl acetate.

Lactone solubilizing agents of the present invention comprise lactones represented by structures [A], [B], and [C]: 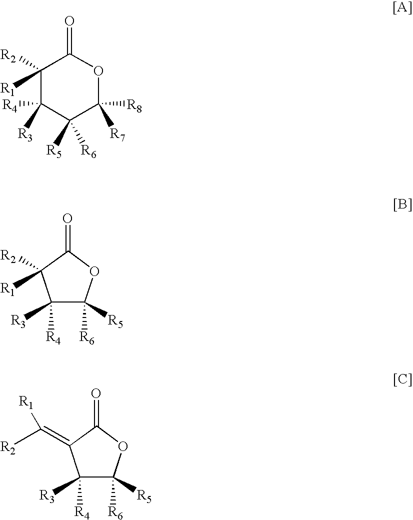
These lactones contain the functional group —CO₂— in a ring of six (A), or preferably five atoms (B), wherein for structures [A] and [B], R₁ through R₈ are independently selected from hydrogen or linear, branched, cyclic, bicyclic, saturated and unsaturated hydrocarbyl radicals. Each R₁ through R₈ may be connected forming a ring with another R₁ through R₈. The lactone may have an exocyclic alkylidene group as in structure [C], wherein R₁ through R₆ are independently selected from hydrogen or linear, branched, cyclic, bicyclic, saturated and unsaturated hydrocarbyl radicals. Each R₁ though R₆ may be connected forming a ring with another R₁ through R₆. The lactone solubilizing agents have a molecular weight range of from about 80 to about 300 atomic mass units, preferred from about 80 to about 200 atomic mass units.

Representative lactone solubilizing agents include but are not limited to the compounds listed in Table 2.

TABLE 2

| | | | Molecular |
|---|---|---|---|
| | | Molecular | Weight |
| Additive | Molecular Structure | Formula | (amu) |
| (E,Z)-3-ethylidene-5- methyl-dihydro-furan-2- one | 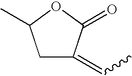 | C₇H₁₀O₂ | 126 |
| (E,Z)-3-propylidene-5- methyl-dihydro-furan-2- one | 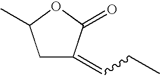 | C₈H₁₂O₂ | 140 |
| (E,Z)-3-butylidene-5- methyl-dihydro-furan-2- one | 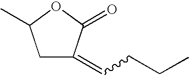 | C₉H₁₄O₂ | 154 |
| (E,Z)-3-pentylidene-5- methyl-dihydro-furan-2- one | 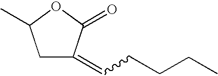 | C₁₀H₁₆O₂ | 168 |
| (E,Z)-3-Hexylidene-5- methyl-dihydro-furan-2- one | 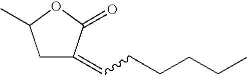 | C₁₁H₁₈O₂ | 182 |
| (E,Z)-3-Heptylidene-5- methyl-dihydro-furan-2- one | 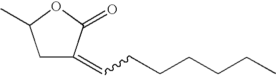 | C₁₂H₂₀O₂ | 196 |
| (E,Z)-3-octylidene-5- methyl-dihydro-furan-2- one | 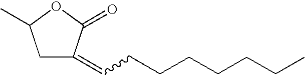 | C₁₃H₂₂O₂ | 210 |
| (E,Z)-3-nonylidene-5- methyl-dihydro-furan-2- one | 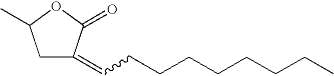 | C₁₄H₂₄O₂ | 224 |
| (E,Z)-3-decylidene-5- methyl-dihydro-furan-2- one | 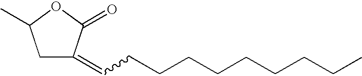 | C₁₅H₂₆O₂ | 238 |
| (E,Z)-3-(3,5,5- trimethylhexylidene)-5- methyl-dihydrofuran-2- one | 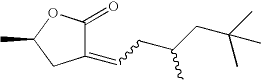 | C₁₄H₂₄O₂ | 224 |
| (E,Z)-3- cyclohexylmethylidene- 5-methyl-dihydrofuran- 2-one | 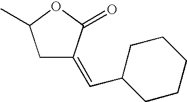 | C₁₂H₁₈O₂ | 194 |
| gamma-octalactone | 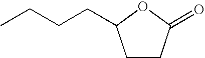 | C₈H₁₄O₂ | 142 |
| gamma-nonalactone | 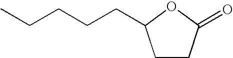 | C₉H₁₆O₂ | 156 |
| gamma-decalactone | 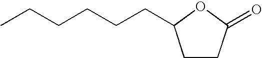 | C₁₀H₁₈O₂ | 170 |
| gamma-undecalactone | 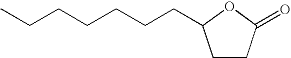 | C₁₁H₂₀O₂ | 184 |
| gamma-dodecalactone | 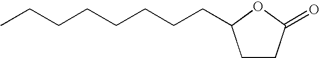 | C₁₂H₂₂O₂ | 198 |
| 3-hexyldihydro-furan-2- one | 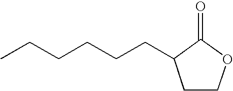 | C₁₀H₁₈O₂ | 170 |
| 3-heptyldihydro-furan- 2-one | 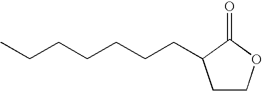 | C₁₁H₂₀O₂ | 184 |
| cis-3-ethyl-5-methyl- dihydro-furan-2-one | 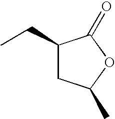 | C₇H₁₂O₂ | 128 |
| cis-(3-propyl-5-methyl)- dihydro-furan-2-one | 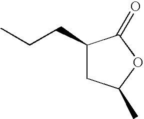 | C₈H₁₄O₂ | 142 |
| cis-(3-butyl-5-methyl)- dihydro-furan-2-one | 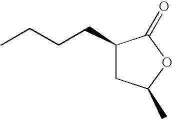 | C₉H₁₆O₂ | 156 |
| cis-(3-pentyl-5-methyl)- dihydro-furan-2-one | 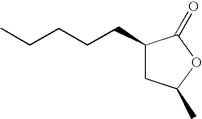 | C₁₀H₁₈O₂ | 170 |
| cis-3-hexyl-5-methyl- dihydro-furan-2-one | 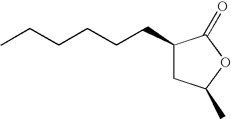 | C₁₁H₂₀O₂ | 184 |
| cis-3-heptyl-5-methyl- dihydro-furan-2-one | 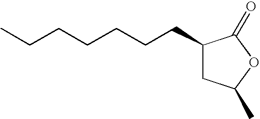 | C₁₂H₂₂O₂ | 198 |
| cis-3-octyl-5-methyl- dihydro-furan-2-one | 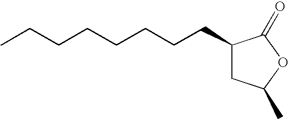 | C₁₃H₂₄O₂ | 212 |
| cis-3-(3,5,5- trimethylhexyl)-5- methyl-dihydro-furan-2- one | 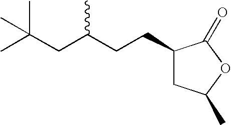 | C₁₄H₂₆O₂ | 226 |
| cis-3-cyclohexylmethyl- 5-methyl-dihydro-furan- 2-one | 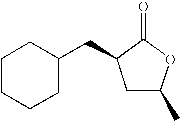 | C₁₂H₂₀O₂ | 196 |
| 5-methyl-5-hexyl- dihydro-furan-2-one | 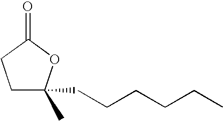 | C₁₁H₂₀O₂ | 184 |
| 5-methyl-5-octyl- dihydro-furan-2-one | 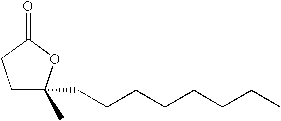 | C₁₃H₂₄O₂ | 212 |
| Hexahydro- isobenzofuran-1-one | 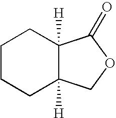 | C₈H₁₂O₂ | 140 |
| delta-decalactone | 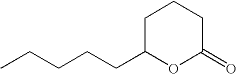 | C₁₀H₁₈O₂ | 170 |
| delta-undecalactone | 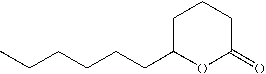 | C₁₁H₂₀O₂ | 184 |
| delta-dodecalactone | 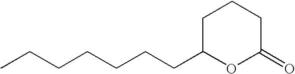 | C₁₂H₂₂O₂ | 198 |
| mixture of 4-hexyl- dihydrofuran-2-one and 3-hexyl-dihydro-furan- 2-one | 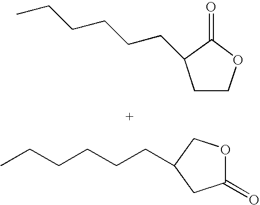 | C₁₀H₁₈O₂ | 170 |

Lactone solubilizing agents generally have a kinematic viscosity of less than about 7 centistokes at 40° C. For instance, gamma-undecalactone has kinematic viscosity of 5.4 centistokes and cis-(3-hexyl-5-methyl)dihydrofuran-2-one has viscosity of 4.5 centistokes both at 40° C. Lactone solubilizing agents may be available commercially or prepared by methods as described in U.S. patent application Ser. No. 10/910,495, filed Aug. 3, 2004, incorporated herein by reference.

Aryl ether solubilizing agents of the present invention further comprise aryl ethers represented by the formula R¹OR², wherein: R¹ is selected from aryl hydrocarbon radicals having from 6 to 12 carbon atoms; R² is selected from aliphatic hydrocarbon radicals having from 1 to 4 carbon atoms; and wherein said aryl ethers have a molecular weight of from about 100 to about 150 atomic mass units. Representative R¹ aryl radicals in the general formula R¹OR² include phenyl, biphenyl, cumenyl, mesityl, tolyl, xylyl, naphthyl and pyridyl. Representative R² aliphatic hydrocarbon radicals in the general formula R¹OR² include methyl, ethyl, propyl, isopropyl, butyl, isobutyl, sec-butyl and tert-butyl. Representative aromatic ether solubilizing agents include but are not limited to: methyl phenyl ether (anisole), 1,3-dimethyoxybenzene, ethyl phenyl ether and butyl phenyl ether.

Fluoroether solubilizing agents of the present invention comprise those represented by the general formula R¹OCF₂CF₂H, wherein R¹ is selected from aliphatic, alicyclic, and aromatic hydrocarbon radicals having from about 5 to about 15 carbon atoms, preferably primary, linear, saturated, alkyl radicals. Representative fluoroether solubilizing agents include but are not limited to: C₈H₁₇OCF₂CF₂H and C₆H₁₃OCF₂CF₂H. It should be noted that if the refrigerant is a fluoroether, then the solubilizing agent may not be the same fluoroether.

Fluoroether solubilizing agents may further comprise ethers derived from fluoro-olefins and polyols. The fluoro-olefins may be of the type CF₂═CXY, wherein X is hydrogen, chlorine or fluorine, and Y is chlorine, fluorine, CF₃ or OR_{f}, wherein R_{f} is CF₃, C₂F₅, or C₃F₇. Representative fluoro-olefins are tetrafluoroethylene, chlorotrifluoroethylene, hexafluoropropylene, and perfluoromethylvinyl ether. The polyols may be linear or branched. Linear polyols may be of the type HOCH₂(CHOH)ₓ(CRR′)_{y}CH₂OH, wherein R and R′ are hydrogen, or CH₃, or C₂H₅ and wherein x is an integer from 0-4, and y is an integer from 0-4. Branched polyols may be of the type C(OH)ₜ(R)ᵤ(CH₂OH)ᵥ[(CH₂)ₘCH₂OH]_{w}, wherein R may be hydrogen, CH₃ or C₂H₅, m may be an integer from 0 to 3, t and u may be 0 or 1, v and w are integers from 0 to 4, and also wherein t+u+v+w=4. Representative polyols are trimethylol propane, pentaerythritol, butanediol, and ethylene glycol.

1,1,1-Trifluoroalkane solubilizing agents of the present invention comprise 1,1,1-trifluoroalkanes represented by the general formula CF₃R¹, wherein R¹ is selected from aliphatic and alicyclic hydrocarbon radicals having from about 5 to about 15 carbon atoms, preferably primary, linear, saturated, alkyl radicals. Representative 1,1,1-trifluoroalkane solubilizing agents include but are not limited to: 1,1,1-trifluorohexane and 1,1,1-trifluorododecane.

Solubilizing agents of the present invention may be present as a single compound, or may be present as a mixture of more than one solubilizing agent. Mixtures of solubilizing agents may contain two solubilizing agents from the same class of compounds, say two lactones, or two solubilizing agents from two different classes, such as a lactone and a polyoxyalkylene glycol ether.

In the present compositions comprising refrigerant and UV fluorescent dye, or comprising heat transfer fluid and UV fluorescent dye, from about 0.001 weight percent to about 1.0 weight percent of the composition is UV dye, preferably from about 0.005 weight percent to about 0.5 weight percent, and most preferably from 0.01 weight percent to about 0.25 weight percent.

Solubility of these UV fluorescent dyes in refrigerant and heat transfer compositions may be poor. Therefore, methods for introducing these dyes into the refrigeration or air-conditioning apparatus have been awkward, costly and time consuming. U.S. Pat. No. RE 36,951, incorporated herein by reference, describes a method, which utilizes a dye powder, solid pellet or slurry of dye that may be inserted into a component of the refrigeration or air-conditioning apparatus. As refrigerant and lubricant are circulated through the apparatus, the dye is dissolved or dispersed and carried throughout the apparatus. Numerous other methods for introducing dye into a refrigeration or air-conditioning apparatus are described in the literature.

Ideally, the UV fluorescent dye could be dissolved in the refrigerant itself thereby not requiring any specialized method for introduction to the refrigeration or air-conditioning apparatus. The present invention relates to compositions including UV fluorescent dye, which may be introduced into the system dissolved in the refrigerant in combination with a solubilizing agent. The inventive compositions will allow the storage and transport of dye-containing refrigerant and heat transfer fluid even at low temperatures while maintaining the dye in solution.

In the present compositions comprising refrigerant, UV fluorescent dye and solubilizing agent, or comprising heat transfer fluid and UV fluorescent dye and solubilizing agent, from about 1 to about 50 weight percent, preferably from about 2 to about 25 weight percent, and most preferably from about 5 to about 15 weight percent of the combined composition is solubilizing agent in the refrigerant or heat transfer fluid. In the compositions of the present invention the UV fluorescent dye is present in a concentration from about 0.001 weight percent to about 1.0 weight percent in the refrigerant or heat transfer fluid, preferably from 0.005 weight percent to about 0.5 weight percent, and most preferably from 0.01 weight percent to about 0.25 weight percent.

Solubilizing agents such as ketones may have an objectionable odor, which can be masked by addition of an odor masking agent or fragrance. Typical examples of odor masking agents or fragrances may include Evergreen, Fresh Lemon, Cherry, Cinnamon, Peppermint, Floral or Orange Peel all of which are commercially available, as well as d-limonene and pinene. Such odor masking agents may be used at concentrations of from about 0.001% to as much as about 15% by weight based on the combined weight of odor masking agent and solubilizing agent.

In yet another embodiment, the present invention relates to a method of using the refrigerant or heat transfer fluid compositions comprising ultraviolet fluorescent dye to detect leaks in refrigeration or air-conditioning apparatus. The presence of the dye in the compositions allows for detection of leaking refrigerant in the refrigeration or air-conditioning apparatus. Leak detection helps one to address, resolve and/or prevent inefficient operation of the apparatus or system or equipment failure. Leak detection also helps one contain chemicals used in the operation of the apparatus.

The method comprises providing the composition comprising refrigerant, ultra-violet fluorescent dye or comprising heat transfer fluid and UV fluorescent dye, as described herein, and optionally, a solubilizing agent as described herein, to refrigeration and air-conditioning apparatus and employing a suitable means for detecting the UV fluorescent dye-containing refrigerant. Suitable means for detecting the dye include, but are not limited to, ultra-violet lamps, often referred to as a “black light” or “blue light”. Such ultra-violet lamps are commercially available from numerous sources specifically designed for detecting UV fluorescent dye. Once the ultra-violet fluorescent dye containing composition has been introduced to the refrigeration or air-conditioning apparatus and has been allowed to circulate throughout the system, a leak can be found by shining said ultra-violet lamp on the apparatus and observing the fluorescence of the dye in the vicinity of any leak point.

In yet another embodiment, the present invention relates to a process for producing refrigeration comprising evaporating the bromofluoro-olefin compositions of the present invention in the vicinity of a body to be cooled, and thereafter condensing said compositions.

In yet another embodiment, the present invention relates to a process for producing heat comprising condensing the bromofluoro-olefin compositions of the present invention in the vicinity of a body to be heated, and thereafter evaporating said compositions.

Mechanical refrigeration is primarily an application of thermodynamics wherein a cooling medium, such as a refrigerant, goes through a cycle so that it can be recovered for reuse. Commonly used cycles include vapor-compression, absorption, steam-jet or steam-ejector, and air.

Vapor-compression refrigeration systems include an evaporator, a compressor, a condenser, and an expansion device. A vapor-compression cycle re-uses refrigerant in multiple steps producing a cooling effect in one step and a heating effect in a different step. The cycle can be described simply as follows. Liquid refrigerant enters an evaporator through an expansion device, and the liquid refrigerant boils in the evaporator at a low pressure to form a gas and produce cooling. The low-pressure gas enters a compressor where the gas is compressed to raise its pressure and temperature. The higher-pressure (compressed) gaseous refrigerant then enters the condenser in which the refrigerant condenses and discharges its heat to the environment. The refrigerant returns to the expansion device through which the liquid expands from the higher-pressure level in the condenser to the low-pressure level in the evaporator, thus repeating the cycle.

There are various types of compressors that may be used in refrigeration applications. Compressors can be generally classified as reciprocating, rotary, jet, centrifugal, scroll, screw or axial-flow, depending on the mechanical means to compress the fluid, or as positive-displacement (e.g., reciprocating, scroll or screw) or dynamic (e.g., centrifugal or jet), depending on how the mechanical elements act on the fluid to be compressed.

Either positive displacement or dynamic compressors may be used in the present inventive processes. A centrifugal type compressor is the preferred equipment for the present refrigerant compositions comprising at least one bromofluoro-olefin.

A centrifugal compressor uses rotating elements to accelerate the refrigerant radially, and typically includes an impeller and diffuser housed in a casing. Centrifugal compressors usually take fluid in at an impeller eye, or central inlet of a circulating impeller, and accelerate it radially outward. Some static pressure rise occurs in the impeller, but most of the pressure rise occurs in the diffuser section of the casing, where velocity is converted to static pressure. Each impeller-diffuser set is a stage of the compressor. Centrifugal compressors are built with from 1 to 12 or more stages, depending on the final pressure desired and the volume of refrigerant to be handled.

The pressure ratio, or compression ratio, of a compressor is the ratio of absolute discharge pressure to the absolute inlet pressure. Pressure delivered by a centrifugal compressor is practically constant over a relatively wide range of capacities.

Positive displacement compressors draw vapor into a chamber, and the chamber decreases in volume to compress the vapor. After being compressed, the vapor is forced from the chamber by further decreasing the volume of the chamber to zero or nearly zero. A positive displacement compressor can build up a pressure, which is limited only by the volumetric efficiency and the strength of the parts to withstand the pressure.

Unlike a positive displacement compressor, a centrifugal compressor depends entirely on the centrifugal force of the high-speed impeller to compress the vapor passing through the impeller. There is no positive displacement, but rather what is called dynamic-compression.

The pressure a centrifugal compressor can develop depends on the tip speed of the impeller. Tip speed is the speed of the impeller measured at its tip and is related to the diameter of the impeller and its revolutions per minute. The capacity of the centrifugal compressor is determined by the size of the passages through the impeller. This makes the size of the compressor more dependent on the pressure required than the capacity.

Because of its high-speed operation, a centrifugal compressor is fundamentally a high volume, low-pressure machine. A centrifugal compressor works best with a low-pressure refrigerant, such as trichlorofluoromethane (CFC-11) or 1,2,2-trichlorotrifluoroethane (CFC-113). Some of the low pressure refrigerant fluids of the present invention may be suitable as drop-in replacements for CFC-113 in existing centrifugal equipment.

The present invention further relates to a method for replacing CFC-113 (1,1,2-trichloro-1,2,2-trifluoroethane) as a refrigerant, said method comprising providing a composition comprising one or more bromofluoro-olefins as the replacement.

Large centrifugal compressors typically operate at 3000 to 7000 revolutions per minute (rpm). Small turbine centrifugal compressors (mini-centrifugal compressors) are designed for high speeds, from about 40,000 to about 70,000 (rpm), and have small impeller sizes, typically less than 0.15 meters (about 6 inches).

A multi-stage impeller may be used in a centrifugal compressor to improve compressor efficiency thus requiring less power in use. For a two-stage system, in operation, the discharge of the first stage impeller goes to the suction intake of a second impeller. Both impellers may operate by use of a single shaft (or axle). Each stage can build up a compression ratio of about 4 to 1; that is, the absolute discharge pressure can be four times the absolute suction pressure. Several examples of two-stage centrifugal compressor systems, particularly for automotive applications, are described in U.S. Pat. No. 5,065,990 and U.S. Pat. No. 5,363,674, both incorporated herein by reference.

The compositions of the present invention suitable for use in refrigeration apparatus or air-conditioning apparatus employing a centrifugal compressor comprise at least one of:

1-bromopentafluoropropene;

2-bromopentafluoropropene;

3-bromopentafluoropropene;

3-bromo-1,1,3,3-tetrafluoropropene;

2-bromo-1,3,3,3-tetrafluoropropene;

1-bromo-2,3,3,3-tetrafluoropropene;

3-bromo-1,1,2-trifluoropropene;

3-bromo-1,3,3-trifluoropropene;

2-bromo-3,3,3-trifluoropropene;

3-bromo-2,3,3-trifluoropropene;

2-bromo- 1,3,3-trifluoropropene;

1-bromo-3,3,3-trifluoropropene;

3-bromo-3,4,4,4-tetrafluoro-1-butene;

2-bromo4,4,4-trifluoro-2-butene;

2-bromo-1,1,1-trifluoro-2-butene;

1-bromo-3,3,3-trifluoro-2-(trifluoromethyl)-propene;

2-bromo-1,1,1,3,4,4,4-heptafluoro-2-butene;

2-bromo-3,3,4,4,4-pentafluoro-1-butene;

1-bromo-3,3,4,4,4,-pentafluoro-1-butene;

2-(bromomethyl)-1,1,3,3,3-pentafluoropropene;

2-(bromodifluoromethyl)-3,3,3-trifluoropropene;

4-bromo-3,3,4,4-tetrafluoro-1-butene;

2-bromo-1,1,3,4,4,5,5,5-octafluoro-2-pentene;

2-bromo-1,1,3,4,4,5,5,5-octafluoro-1-pentene;

2-bromo-3,4,4,4-tetrafluoro-3-(trifluoromethyl)-1-butene;

1-bromo-2,3,3,4,4,5,5-heptafluoro-1-pentene;

2-bromo-3,3,4,4,5,5,5-heptafluoro-1-pentene;

1-bromo4,4,4-trifluoro-3-(trifluoromethyl)-1-butene;

4-bromo-1,1,1-trifluoro-2-(trifluoromethyl)-2-butene;

3-(bromodifluoromethyl)-3,4,4,4-tetrafluoro-1-butene;

5-bromo-1,1,3,3,5,5-hexafluoro-1-pentene; or

3-bromo-1,1,1,2,4,4,5,5,5-nonafluoro-2-pentene.

These above-listed compositions are also suitable for use in a multi-stage centrifugal compressor, preferably a two-stage centrifugal compressor apparatus.

The compositions of the present invention may be used in stationary air-conditioning, heat pumps or mobile air-conditioning and refrigeration systems. Stationary air-conditioning and heat pump applications include window, ductless, ducted, packaged terminal, chillers and commercial, including packaged rooftop. Refrigeration applications include domestic or home refrigerators and freezers, ice machines, self-contained coolers and freezers, walk-in coolers and freezers and transport refrigeration systems.

The compositions of the present invention may additionally be used in air-conditioning, heating and refrigeration systems that employ fin and tube heat exchangers, microchannel heat exchangers and vertical or horizontal single pass tube or plate type heat exchangers.

Conventional microchannel heat exchangers may not be ideal for the low pressure refrigerant compositions of the present invention. The low operating pressure and density result in high flow velocities and high frictional losses in all components. In these cases, the evaporator design may be modified. Rather than several microchannel slabs connected in series (with respect to the refrigerant path) a single slab/single pass heat exchanger arrangement may be used. Therefore, a preferred heat exchanger for the low pressure refrigerants of the present invention is a single slab/single pass heat exchanger.

In addition to two-stage or other multi-stage centrifugal compressor apparatus, the following compositions of the present invention are suitable for use in refrigeration apparatus or air-conditioning apparatus employing a single slab/single pass heat exchanger:

1-bromopentafluoropropene;

2-bromopentafluoropropene;

3-bromopentafluoropropene;

3-bromo-1,1,3,3-tetrafluoropropene;

2-bromo-1,3,3,3-tetrafluoropropene;

1-bromo-2,3,3,3-tetrafluoropropene;

3-bromo-1,1,2-trifluoropropene;

3-bromo-1,3,3-trifluoropropene;

2-bromo-3,3,3-trifluoropropene;

3-bromo-2,3,3-trifluoropropene;

2-bromo-1,3,3-trifluoropropene;

1-bromo-3,3,3-trifluoropropene;

3-bromo-3,4,4,4-tetrafluoro-1-butene;

2-bromo-4,4,4-trifluoro-2-butene;

2-bromo-1,1,1-trifluoro-2-butene;

1-bromo-3,3,3-trifluoro-2-(trifluoromethyl)-propene;

2-bromo-1,1,1,3,4,4,4-heptafluoro-2-butene;

2-bromo-3,3,4,4,4-pentafluoro-1-butene;

1-bromo-3,3,4,4,4,-pentafluoro-1-butene;

2-(bromomethyl)-1,1,3,3,3-pentafluoropropene;

2-(bromodifluoromethyl)-3,3,3-trifluoropropene;

4-bromo-3,3,4,4-tetrafluoro-1-butene;

2-bromo-1,1,3,4,4,5,5,5-octafluoro-2-pentene;

2-bromo-1,1,3,4,4,5,5,5-octafluoro-1-pentene;

2-bromo-3,4,4,4-tetrafluoro-3-(trifluoromethyl)-1-butene;

1-bromo-2,3,3,4,4,5,5-heptafluoro-1-pentene;

2-bromo-3,3,4,4,5,5,5-heptafluoro-1-pentene;

1-bromo-4,4,4-trifluoro-3-(trifluoromethyl)-1-butene;

4-bromo-1 1,1-trifluoro-2-(trifluoromethyl)-2-butene;

3-(bromodifluoromethyl)-3,4,4,4-tetrafluoro-1-butene;

5-bromo-1,1,3,3,5,5-hexafluoro-1-pentene; and

3-bromo-1,1,1,2,4,4,5,5,5-nonafluoro-2-pentene.

In one embodiment, the present invention relates to a process to produce cooling comprising compressing a composition comprising at least one bromofluoro-olefin in a centrifugal compressor, condensing said composition, and thereafter evaporating said composition in the vicinity of a body to be cooled. Additionally, the centrifugal compressor of the inventive method may be a multi-stage centrifugal compressor or specifically a 2-stage centrifugal compressor.

In another embodiment, the present invention relates to a process to produce cooling in a refrigeration apparatus or air-conditioning apparatus, wherein said refrigeration apparatus or air-conditioning apparatus comprises at least one single slab/single pass heat exchanger, said process comprising condensing a composition of the present invention, and thereafter evaporating said composition in the vicinity of a body to be cooled.

In yet another embodiment, the present invention relates to a process to produce cooling in a refrigeration apparatus or air-conditioning apparatus, wherein said refrigeration apparatus or air-conditioning apparatus comprises at least one single slab/single pass heat exchanger, said process comprising compressing a composition of the present invention, in a centrifugal compressor, condensing said composition, and thereafter evaporating said composition in the vicinity of a body to be cooled.

The compositions of the present invention are particularly useful in small turbine centrifugal compressors (mini-centrifugal compressors), which can be used in auto and window air-conditioning, heat pumps, or transport refrigeration, as well as other applications. These high efficiency mini-centrifugal compressors may be driven by an electric motor and can therefore be operated independently of the engine speed. A constant compressor speed allows the system to provide a relatively constant cooling capacity at all engine speeds. This provides an opportunity for efficiency improvements especially at higher engine speeds as compared to a conventional R-134a automobile air-conditioning system. When the cycling operation of conventional systems at high driving speeds is taken into account, the advantage of these low pressure systems becomes even greater.

Alternatively, rather than use electrical power, the mini-centrifugal compressor may be powered by an engine exhaust gas driven turbine or a ratioed gear drive assembly with ratioed belt drive. The electrical power available in current automobile design is about 14 volts, but the new mini-centrifugal compressor requires electrical power of about 50 volts. Therefore, use of an alternative power source would be advantageous. A refrigeration apparatus or air-conditioning apparatus powered by an engine exhaust gas driven turbine is described in detail in U.S. provisional patent application No. 60/658,915, filed Mar. 4, 2005, incorporated herein by reference. A refrigeration apparatus or air-conditioning apparatus powered by a ratioed gear drive assembly is described in detail in U.S. provisional patent application No. 60/663924, filed Mar. 21, 2005, incorporated herein by reference.

In another embodiment, the present invention relates to a process to produce cooling comprising compressing a composition of the present invention, in a mini-centrifugal compressor powered by an engine exhaust gas driven turbine; condensing said composition; and thereafter evaporating said composition in the vicinity of a body to be cooled.

In yet another embodiment, the present invention relates to a process to produce cooling comprising compressing a composition of the present invention, in a mini-centrifugal compressor powered by a ratioed gear drive assembly with a ratioed belt drive; condensing said composition; and thereafter evaporating said composition in the vicinity of a body to be cooled.

In yet another embodiment, the present invention relates to a process to produce cooling in a refrigeration apparatus or air-conditioning apparatus, wherein said refrigeration apparatus or air-conditioning apparatus comprises at least one single slab/single pass heat exchanger, said process comprising compressing a composition of the present invention, in a centrifugal compressor, condensing said composition, and thereafter evaporating said composition in the vicinity of a body to be cooled.

The fluoroether refrigerants of the present invention may comprise compounds similar to hydrofluorocarbons, which also contain at least one ether group oxygen atom. The fluoroether refrigerants include but are not limited to C₄F₉OCH₃, and C₄F₉OC₂H₅ (both available commercially).

The refrigerants of the present invention may optionally further comprise combinations of refrigerants that contain up to 10 weight percent of dimethyl ether, or at least one C₃ to C₅ hydrocarbon, e.g., propane, propylene, cyclopropane, n-butane, isobutane, n-pentane, cyclopentane and neopentane (2,2-dimethylpropane). Examples of refrigerants containing such C₃ to C₅ hydrocarbons are azeotrope-like compositions of HCFC-22/HFC-125/propane (known by the ASHRAE designation, R-402), HCFC-22/octafluoropropane/propane (known by the ASHRAE designation, R-403), octafluoropropane/HFC-134a/isobutane (known by the ASHRAE designation, R-413), HCFC-22/HCFC-124/HCFC-142b/isobutane (known by the ASHRAE designation ,R-414), HFC-134a/HCFC-124/n-butane (known by the ASHRAE designation, R-416), HFC-125/HFC-1 34a/n-butane (known by the ASHRAE designation, R-417), HFC-125/HFC-134a/dimethyl ether (known by the ASHRAE designation, R-419), and HFC-125/HFC-134a/isobutane (known by ASHRAE designation, R-422).

The bromofluoro-olefins of the present invention that may be combined with fluoroether refrigerants, hydrocarbon ether refrigerants, or combinations of refrigerants to lower the GWP comprise at least one bromofluoro-olefin selected from the group consisting of:

1-bromopentafluoropropene;

2-bromopentafluoropropene;

3-bromopentafluoropropene;

2-bromo-1,3,3,3-tetrafluoropropene;

1-bromo-2,3,3,3-tetrafluoropropene;

3-bromo-1,1,2-trifluoropropene;

3-bromo-1,3,3-trifluoropropene;

3-bromo-2, 3,3-trifluoropropene;

2-bromo-1,3,3-trifluoropropene;

3-bromo-3,4,4,4-tetrafluoro-1-butene;

2-bromo-4,4,4-trifluoro-2-butene;

2-bromo-1,1,1-trifluoro-2-butene;

1-bromo-3,3,3-trifluoro-2-(trifluoromethyl)-propene;

2-bromo-1,1,1,3,4,4,4-heptafluoro-2-butene;

1-bromo-3,3,4,4,4,-pentafluoro-1-butene;

2-(bromomethyl)-1,1,3,3,3-pentafluoropropene;

2-(bromodifluoromethyl)-3,3,3-trifluoropropene;

2-bromo-1,1,3,4,4,5,5,5-octafluoro-2-pentene;

2-bromo-1,1,3,4,4,5,5,5-octafluoro-1-pentene;

2-bromo-3,4,4,4-tetrafluoro-3-(trifluoromethyl)-1-butene;

1-bromo-2,3,3,4,4,5,5-heptafluoro-1-pentene;

1-bromo4,4,4-trifluoro-3-(trifluoromethyl)-1-butene;

4-bromo-1,1,1-trifluoro-2-(trifluoromethyl)-2-butene;

3-(bromodifluoromethyl)-3,4,4,4-tetrafluoro-1-butene;

5-bromo-1,1,3,3,5,5-hexafluoro-1-pentene; and

3-bromo-1,1,1,2,4,4,5,5,5-nonafluoro-2-pentene.

In one embodiment, the present invention relates to a method for reducing the fire-hazard in refrigeration apparatus or air-conditioning apparatus, said method comprising introducing a composition of the present invention into said refrigerant apparatus or air-conditioning apparatus.

Flammability of a refrigerant that may leak from an air-conditioning apparatus or refrigeration apparatus is a major concern. Should a leak occur in a refrigeration apparatus or air-conditioning apparatus, refrigerant and potentially a small amount of lubricant may be released from the system. If this leaking material comes in contact with an ignition source, a fire may result. By fire-hazard is meant the probability that a fire may occur either within or in the vicinity of a refrigeration apparatus or air-conditioning apparatus. Reducing the fire-hazard in a refrigeration apparatus or air-conditioning system may be accomplished by using a refrigerant or heat transfer fluid that is not considered flammable as determined and defined by the methods and standards described previously herein. Additionally, the bromofluoro-olefins of the present invention may be added to a flammable refrigerant or heat transfer fluid, said flammable refrigerant or heat transfer fluid being contained either within a refrigeration apparatus or air-conditioning apparatus or within an external container prior to loading into the apparatus. The bromofluoro-olefins of the present invention reduce the probability of a fire in the event of a leak and/or reduce the degree of fire hazard by reducing the temperature or size of any flame produced.

The present invention further relates to a method for reducing fire-hazard in or in the vicinity of a refrigeration apparatus or air-conditioning apparatus, said method comprising combining at least one bromofluoro-olefin with a flammable refrigerant and introducing the combination into a refrigeration apparatus or air-conditioning apparatus.

In another embodiment, the present invention relates to a method for reducing fire-hazard in or in the vicinity of a refrigeration apparatus or air-conditioning apparatus, said method comprising combining at least one bromofluoro-olefin with a lubricant and introducing the combination into a refrigeration apparatus or air-conditioning apparatus comprising flammable refrigerant.

In yet another embodiment, the present invention relates to a method for reducing fire-hazard in or in the vicinity of a refrigeration apparatus or air-conditioning apparatus, said method comprising introducing at least one bromofluoro-olefin into said refrigeration apparatus or air-conditioning apparatus.

In yet another embodiment, the present invention relates to a method of using a flammable refrigerant in refrigeration apparatus or air-conditioning apparatus, said method comprising combining said flammable refrigerant with a composition comprising one or more bromofluoro-olefins.

In yet another embodiment, the present invention relates to a method for reducing flammability of a flammable refrigerant or heat transfer fluid, said method comprising combining the flammable refrigerant with a bromofluoro-olefin.

In yet another embodiment, the present invention relates to a process for transfer of heat from a heat source to a heat sink wherein the compositions of the present invention serve as heat transfer fluids. Said process for heat transfer comprises transporting the compositions of the present invention from a heat source to a heat sink.

Heat transfer fluids are utilized to transfer, move or remove heat from one space, location, object or body to a different space, location, object or body by radiation, conduction, or convection. A heat transfer fluid may function as a secondary coolant by providing means of transfer for cooling (or heating) from a remote refrigeration (or heating) system. In some systems, the heat transfer fluid may remain in a constant state throughout the transfer process (i.e., not evaporate or condense). Alternatively, evaporative cooling processes may utilize heat transfer fluids as well.

A heat source may be defined as any space, location, object or body from which it is desirable to transfer, move or remove heat. Examples of heat sources may be spaces (open or enclosed) requiring refrigeration or cooling, such as refrigerator or freezer cases in a supermarket, building spaces requiring air-conditioning, or the passenger compartment of an automobile requiring air-conditioning. A heat sink may be defined as any space, location, object or body capable of absorbing heat. A vapor compression refrigeration system is one example of such a heat sink.

The compositions of the present invention that are combinations or mixtures of bromofluoro-olefins; or combinations or mixtures of bromofluoro-olefins and other refrigerants or heat transfer fluids; or combinations or mixtures of these first two types that additionally contain other additives, may all be prepared by any convenient method to combine the desired amounts of the individual components. A preferred method is to weigh the desired component amounts and thereafter combine the components in an appropriate vessel. Agitation may be used, if desired.

### EXAMPLES

### Example 1

### Tip Speed to Develop Pressure

Tip speed can be estimated by making some fundamental relationships for refrigeration equipment that use centrifugal compressors. The torque an impeller ideally imparts to a gas is defined as
T=m*(v₂*r₂-v₁*r₁) Equation 1
where

T=torque, Newton-meters

m=mass rate of flow, kg/sec

v₂=tangential velocity of refrigerant leaving impeller (tip speed), meters/sec

r₂=radius of exit impeller, meters

v₁=tangential velocity of refrigerant entering impeller, meters/sec

r₁=radius of inlet of impeller, meters

Assuming the refrigerant enters the impeller in an essentially axial direction, the tangential component of the velocity v₁=0, therefore
T=m*v₂*r₂ Equation 2

The power required at the shaft is the product of the torque and the rotative speed
P=T*ω Equation 3
where

P=power, W

ω=angular velocity, radians/s

therefore,
P=T*w=m*v₂*r₂*ω Equation 4

At low refrigerant flow rates, the tip speed of the impeller and the tangential velocity of the refrigerant are nearly identical; therefore
r₂*ω=v₂ Equation 5
and
P=m*v₂*v₂ Equation 6

Another expression for ideal power is the product of the mass rate of flow and the isentropic work of compression,
P=m*Hᵢ*(1000 J/kJ) Equation 7
where

Hᵢ=Difference in enthalpy of the refrigerant from a saturated vapor at the evaporating conditions to saturated condensing conditions, kJ/kg.

Combining the two expressions Equation 6 and 7 produces,
v₂*v₂=1000*Hᵢ Equation 8

Although Equation 8 is based on some fundamental assumptions, it provides a good estimate of the tip speed of the impeller and provides an important way to compare tip speeds of refrigerants.

Table 3 below shows theoretical tip speeds that are calculated for 1,2,2-trichlorotrifluoroethane (CFC-113) and compositions of the present invention. The conditions assumed for this comparison are:

| Evaporator temperature | 40.0° F. (4.4° C.) |
|---|---|
| Condenser temperature | 110.0° F. (43.3° C.) |
| Liquid subcool temperature | 10.0° F. (5.5° C.) |
| Return gas temperature | 75.0° F. (23.8° C.) |
| Compressor efficiency is | 70% |

These are typical conditions under which small turbine centrifugal compressors perform.

TABLE 3

| | Hi | Hi*0.7 | Hi*0.7 | V2 | V2 rel |
|---|---|---|---|---|---|
| Compound | Btu/lb | Btu/lb | KJ/Kg | m/s | to CFC-113 |
| CFC-113 | 10.92 | 7.6 | 17.8 | 133.3 | n/a |
| 4-bromo-3,3,4,4-tetrafluoro-1-butene | 9.99 | 7.0 | 16.3 | 127.5 | 96% |
| 1-bromo-3,3,4,4,4-pentafluoro-1-butene | 9.75 | 6.8 | 15.9 | 126.0 | 95% |
| 1-bromo-2,3,3,3-tetrafluoropropene | 8.38 | 5.9 | 13.6 | 116.8 | 88% |
| 2-bromo-1,1,1,3,4,4,4-heptafluoro-2-butene | 9.57 | 6.7 | 15.6 | 124.8 | 94% |
| 2-bromo-pentafluoropropene | 8.77 | 6.1 | 14.3 | 119.5 | 90% |
| 3-bromo-1,1,3,3-tetrafluoropropene | 8.23 | 5.8 | 13.4 | 115.8 | 87% |
| 1-bromopentafluoro-propene | 8.80 | 6.2 | 14.3 | 119.7 | 90% |
| 2-bromo-1,3,3,3-tetrafluoropropene | 8 | 5.7 | 13.4 | 115.5 | 87% |
| 2-bromo-3,3,4,4,4-pentafluoro-1-butene | 9.91 | 6.9 | 16.1 | 127.0 | 95% |
| 3-bromo-1,1,1,2,4,4,5,5,5-nonafluoro-2-pentene | 10.08 | 7.1 | 16.4 | 128.1 | 96% |
| 2-bromo-3,3,3-trifluoropropene | 9.11 | 6.4 | 14.8 | 121.8 | 91% |

The example shows that compounds of the present invention have tip speeds within about 15 percent of CFC-113 and would be effective replacements for CFC-113 with minimal compressor design changes. Most preferred compositions have tip speeds within about 10 percent of CFC-113.

### Example 2

### Performance Data

Table 4 shows the performance of various refrigerants compared to CFC-113. The data are based on the following conditions.

| Evaporator temperature | 40.0° F. (4.4° C.) |
|---|---|
| Condenser temperature | 110.0° F. (43.3° C.) |
| Subcool temperature | 10.0° F. (5.5° C.) |
| Return gas temperature | 75.0° F. (23.8° C.) |
| Compressor efficiency is | 70% |

TABLE 4

| | | | | | Comp | Comp | | | |
|---|---|---|---|---|---|---|---|---|---|
| | Evap | Evap | Cond | Cond | Disch | Disch | | | |
| | Pres | Pres | Pres | Pres | T | T | Capacity | Capacity | |
| Compound | (Psia) | (kPa) | (Psia) | (kPa) | (F.) | (C.) | (Btu/min) | (kW) | COP |
| CFC-113 | 2.7 | 19 | 12.8 | 88 | 156.3 | 69.1 | 14.8 | 0.29 | 4.18 |
| 4-bromo-3,3,4,4- | 1.42 | 10 | 9.14 | 63 | 168.5 | 75.8 | 11.04 | 0.21 | 4.27 |
| tetrafluoro-1-butene | | | | | | | | | |
| 1-bromo-3,3,4,4,4- | 1.22 | 8 | 8.2 | 57 | 165.7 | 74.3 | 9.65 | 0.19 | 4.25 |
| pentafluoro-1-butene | | | | | | | | | |
| 1-bromo-2,3,3,3- | 2.15 | 15 | 12.85 | 89 | 189.2 | 87.3 | 16.47 | 0.32 | 4.32 |
| tetrafluoropropene | | | | | | | | | |
| 2-bromo-1,1,1,3,4,4,4- | 2.14 | 15 | 11.84 | 82 | 146.5 | 63.6 | 14.49 | 0.28 | 4.12 |
| heptafluoro-2-butene | | | | | | | | | |
| 2-bromo- | 5.78 | 40 | 27.6 | 190 | 161.7 | 72.1 | 36.65 | 0.71 | 4.19 |
| pentafluoropropene | | | | | | | | | |
| 3-bromo-1,1,3,3- | 3.93 | 27 | 21.24 | 146 | 183.2 | 84.0 | 28.00 | 0.54 | 4.29 |
| tetrafluoropropene | | | | | | | | | |
| 1-bromopentafluoro- | 5.29 | 36 | 25.65 | 177 | 162.3 | 72.4 | 34.00 | 0.66 | 4.21 |
| propene | | | | | | | | | |
| 2-bromo-1,3,3,3- | 4.41 | 30 | 23.37 | 161 | 182.1 | 83.4 | 30.95 | 0.60 | 4.28 |
| tetrafluoropropene | | | | | | | | | |
| 2-bromo-3,3,4,4,4- | 1.29 | 9 | 7.98 | 55 | 160.2 | 71.2 | 9.70 | 0.19 | 4.24 |
| pentafluoro-1-butene | | | | | | | | | |
| 3-bromo- | 0.86 | 6 | 5.6 | 39 | 137.9 | 58.8 | 6.24 | 0.12 | 4.05 |
| 1,1,1,2,4,4,5,5,5- | | | | | | | | | |
| nonafluoro-2-pentene | | | | | | | | | |
| 2-bromo-3,3,3- | 3.55 | 24 | 19.42 | 134 | 184.4 | 84.7 | 25.64 | 0.50 | 4.31 |
| trifluoropropene | | | | | | | | | |

Advantageously, several compounds have even higher capacity and/or energy efficiency (COP) than CFC-113.

### Example 3

### Fire Extinguishing Concentration

A useful test for screening compounds for use in extinguishing or suppressing fire is the ICI Cup Burner method. This method is described in “Measurement of Flame-Extinguishing Concentrations” R. Hirst and K. Booth, Fire Technology, vol. 13(4): 296-315 (1977). The method is used here to demonstrate similar fire suppression properties of the fluoro-olefins of the present invention to compounds that have traditionally been used for fire extinguishing or fire suppression. Thus, compositions comprising one or more fluoro-olefins may have particular utility in applications requiring non-flammable refrigerant.

Specifically, an air stream is passed at 40 liters/minute through an outer chimney (8.5 cm. I. D. by 53 cm. tall) from a glass bead distributor at its base. A fuel cup burner (3.1 cm. O.D. and 2.15 cm. I.D.) is positioned within the chimney at 30.5 cm. below the top edge of the chimney. The fire extinguishing agent is added to the air stream prior to its entry into the glass bead distributor while the air flow rate is maintained at 40 liters/minute for all tests. The air and agent flow rates are measured using calibrated rotameters.

The test is conducted by adjusting the fuel (n-heptane) level in the reservoir to bring the liquid fuel level in the cup burner just even with the ground glass lip on the burner cup. With the air flow rate maintained at 40 liters/minute, the fuel in the cup burner is ignited. The fire extinguishing agent is added in measured increments until the flame is extinguished.

The fire extinguishing concentration is determined from the following equation: Extinguishing concentration=(F₁/(F₁+F₂))×100, where F₁ is the agent flow rate and F₂ is the air flow rate.

TABLE 5

| | FIRE EXTINGUISHING |
|---|---|
| | CONCENTRATION |
| FIRE EXTINGUISHING AGENT | (volume % in air) |
| EXAMPLE | |
| BTFB (4-bromo-3,3,4,4-tetrafluoro- | 4.1 |
| 1-butene, CH₂═CHCF₂CF₂Br) | |
| COMPARATIVE | |
| CF₃CHFCF₃ (HFC-227ea) | 7.3 |
| CF₃CHFCHF₂ (HFC-236ea) | 10.2 |
| CF₃CF₂CH₂Cl (HCFC-235cb) | 6.2 |
| CF₄ | 20.5 |
| C₂F₆ | 8.7 |
| CF₃Br (Halon-1301) | 4.2 |
| CF₂ClBr (Halon 1211) | 6.2 |
| CHF₂Cl | 13.6 |

What is claimed is:

1. A refrigerant or heat transfer fluid composition comprising at least one bromofluoro-olefin selected from the group consisting of:
1-bromopentafluoropropene;
2-bromopentafluoropropene;
3-bromopentafluoropropene;
3-bromo-1,1,3,3-tetrafluoropropene;
2-bromo-1,3,3,3-tetrafluoropropene;
1-bromo-2,3,3,3-tetrafluoropropene;
3-bromo-1,1,2-trifluoropropene;
3-bromo-1,3,3-trifluoropropene;
2-bromo-3,3,3-trifluoropropene;
3-bromo-2,3,3-trifluoropropene;
2-bromo-1,3,3-trifluoropropene;
1-bromo-3,3,3-trifluoropropene;
3-bromo-3,4,4,4-tetrafluoro-1-butene;
2-bromo-4,4,4-trifluoro-2-butene;
2-bromo-1,1,1-trifluoro-2-butene;
1-bromo-3,3,3-trifluoro-2-(trifluoromethyl)-propene;
2-bromo-1,1,1,3,4,4,4-heptafluoro-2-butene;
2-bromo-3,3,4,4,4-pentafluoro-1-butene;
1-bromo-3,3,4,4,4,-pentafluoro-1-butene;
2-(bromomethyl)-1,1,3,3,3-pentafluoropropene;
2-(bromodifluoromethyl)-3,3,3-trifluoropropene;
4-bromo-3,3,4,4-tetrafluoro-1-butene;
2-bromo-1,1,3,4,4,5,5,5-octafluoro-2-pentene;
2-bromo-1,1,3,4,4,5,5,5-octafluoro-1-pentene;
2-bromo-3,4,4,4-tetrafluoro-3-(trifluoromethyl)-1-butene;
1-bromo-2,3,3,4,4,5,5-heptafluoro-1-pentene;
2-bromo-3,3,4,4,5,5,5-heptafluoro-1-pentene;
1-bromo-4,4,4-trifluoro-3-(trifluoromethyl)-1-butene;
4-bromo-1,1,1-trifluoro-2-(trifluoromethyl)-2-butene;
3-(bromodifluoromethyl)-3,4,4,4-tetrafluoro-1-butene;
5-bromo-1,1,3,3,5,5-hexafluoro-1-pentene; and
3-bromo-1,1,1,2,4,4,5,5,5-nonafluoro-2-pentene.

2. A composition as in claim 1 further comprising a flammable refrigerant or heat transfer fluid selected from the group consisting of fluoroethers, hydrocarbon ethers, and combinations thereof.

3. A composition as in claim 2 wherein the said flammable refrigerant or heat transfer fluid is selected from the group consisting of:
C₄F₉OC₂H₅;
dimethylether;
and combinations thereof.

4. A composition as in claim 3, comprising 4-bromo-3,3,4,4-tetrafluoro-1-butene and C₄F₉OC₂H₅.

5. A composition as in claim 1 wherein said refrigerant or heat transfer fluid composition is suitable for use in refrigeration or air-conditioning apparatus employing (i) a centrifugal compressor or (ii) a multi-stage centrifugal compressor or (iii) a single slab/single pass heat exchanger.

6. A composition as in claim 1 further comprising a lubricant selected from the group consisting of mineral oils, paraffins, naphthenes, synthetic paraffins, alkylbenzenes, poly-alpha-olefins, polyalkylene glycols, polyvinyl ethers, polyol esters and mixtures thereof.

7. A composition as in claim 4 further comprising a lubricant selected from the group consisting of mineral oils, paraffins, naphthenes, synthetic paraffins, alkylbenzenes, poly-alpha-olefins, polyalkylene glycols, polyvinyl ethers, polyol esters and mixtures thereof.

8. The composition of claim 1 further comprising a stabilizer, water scavenger, or odor masking agent.

9. The composition of claim 8 wherein said stabilizer is selected from the group consisting of nitromethane, hindered phenols, hydroxylamines, thiols, phosphates, epoxides and lactones.

10. A process for producing cooling said process comprising condensing the composition of claim 1 and thereafter evaporating said composition in the vicinity of a body to be cooled.

11. A process for producing heating said process comprising evaporating the composition of claim 1 and thereafter condensing said composition in the vicinity of a body to be heated.

12. The composition of claim 1 further comprising at least one ultra-violet fluorescent dye selected from the group consisting of naphthalimides, perylenes, coumarins, anthracenes, phenanthracenes, xanthenes, thioxanthenes, naphthoxanthenes, fluoresceins, and derivatives of said dye and combinations thereof.

13. The composition of claim 12, further comprising at least one solubilizing agent selected from the group consisting of hydrocarbons, dimethylether, polyoxyalkylene glycol ethers, amides, ketones, nitriles, chlorocarbons, esters, lactones, aryl ethers, fluoroethers, and 1,1,1-trifluoroalkanes.

14. The composition of claim 13, wherein said solubilizing agent is selected from the group consisting of:
a) polyoxyalkylene glycol ethers represented by the formula R¹[(OR²)ₓOR³]_{y}, wherein: x is an integer from 1 to 3; y is an integer from 1 to 4; R¹ is selected from hydrogen and aliphatic hydrocarbon radicals having 1 to 6 carbon atoms and y bonding sites; R² is selected from aliphatic hydrocarbylene radicals having from 2 to 4 carbon atoms; R³ is selected from hydrogen, and aliphatic and alicyclic hydrocarbon radicals having from 1 to 6 carbon atoms; at least one of R¹ and R³ is selected from said hydrocarbon radicals; and wherein said polyoxyalkylene glycol ethers have a molecular weight of from about 100 to about 300 atomic mass units;
b) amides represented by the formulae R¹C(O)NR²R³ and cyclo-[R⁴CON(R⁵)—], wherein R¹, R², R³ and R⁵ are independently selected from aliphatic and alicyclic hydrocarbon radicals having from 1 to 12 carbon atoms, and at most one aromatic radical having from 6 to 12 carbon atoms; R⁴ is selected from aliphatic hydrocarbylene radicals having from 3 to 12 carbon atoms; and wherein said amides have a molecular weight of from about 100 to about 300 atomic mass units;
c) ketones represented by the formula R¹C(O)R², wherein R¹ and R² are independently selected from aliphatic, alicyclic and aryl hydrocarbon radicals having from 1 to 12 carbon atoms, and wherein said ketones have a molecular weight of from about 70 to about 300 atomic mass units;
d) nitriles represented by the formula R¹CN, wherein R¹ is selected from aliphatic, alicyclic or aryl hydrocarbon radicals having from 5 to 12 carbon atoms, and wherein said nitriles have a molecular weight of from about 90 to about 200 atomic mass units;
e) chlorocarbons represented by the formula RClₓ, wherein; x is 1 or 2; R is selected from aliphatic and alicyclic hydrocarbon radicals having from 1 to 12 carbon atoms; and wherein said chlorocarbons have a molecular weight of from about 100 to about 200 atomic mass units;
f) aryl ethers represented by the formula R¹OR², wherein: R¹ is selected from aryl hydrocarbon radicals having from 6 to 12 carbon atoms; R² is selected from aliphatic hydrocarbon radicals having from 1 to 4 carbon atoms; and wherein said aryl ethers have a molecular weight of from about 100 to about 150 atomic mass units;
g) 1,1,1-trifluoroalkanes represented by the formula CF₃R¹, wherein R¹ is selected from aliphatic and alicyclic hydrocarbon radicals having from about 5 to about 15 carbon atoms;
h) fluoroethers represented by the formula R¹OCF₂CF₂H, wherein R¹ is selected from aliphatic, alicyclic, and aromatic hydrocarbon radicals having from about 5 to about 15 carbon atoms; or wherein said fluoroethers are derived from fluoro-olefins and polyols, wherein said fluoro-olefins are of the type CF₂═CXY, wherein X is hydrogen, chlorine or fluorine, and Y is chlorine, fluorine, CF₃ or OR_{f}, wherein R_{f} is CF₃, C₂F₅, or C₃F₇; and said polyols are linear or branched, wherein said linear polyols are of the type HOCH₂(CHOH)ₓ(CRR′)_{y}CH₂OH, wherein R and R′ are hydrogen, CH₃ or C₂H₅, x is an integer from 0-4, y is an integer from 0-3 and z is either zero or 1, and said branched polyols are of the type C(OH)ₜ(R)ᵤ(CH₂OH)ᵥ[(CH₂)ₘCH₂OH]_{w}, wherein R may be hydrogen, CH₃ or C₂H₅, m is an integer from 0 to 3, t and u are 0 or 1, v and w are integers from 0 to 4, and also wherein t+u+v+w=4;and
i) lactones represented by structures [A], [B], and [C]: 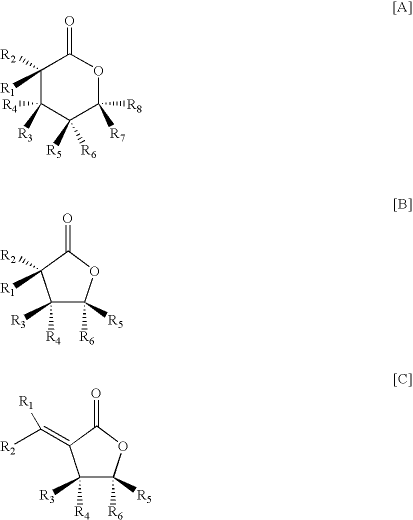
wherein, R₁ through R₈ are independently selected from hydrogen, linear, branched, cyclic, bicyclic, saturated and unsaturated hydrocarbyl radicals; and the molecular weight is from about 100 to about 300 atomic mass units; and
j) esters represented by the general formula R¹CO₂R², wherein R¹ and R² are independently selected from linear and cyclic, saturated and unsaturated, alkyl and aryl radicals; and wherein said esters have a molecular weight of from about 80 to about 550 atomic mass units.

15. A composition as in claim 4 further comprising at least one ultra-violet fluorescent dye selected from the group consisting of naphthalimides, perylenes, coumarins, anthracenes, phenanthracenes, xanthenes, thioxanthenes, naphthoxanthenes, fluoresceins, and derivatives of said dye and combinations thereof.

16. A method for detecting the composition of either of claims 12 or 15 in refrigeration or air-conditioning apparatus, said method comprising providing said composition to said apparatus, and providing a suitable means for detecting said composition at a leak point or in the vicinity of said apparatus.

17. A method for reducing flammability of a flammable refrigerant, said method comprising combining said flammable refrigerant with at least one bromofluoro-olefin refrigerant selected from the group consisting of:
1-bromopentafluoropropene;
2-bromopentafluoropropene;
3-bromopentafluoropropene;
3-bromo-1,1,3,3-tetrafluoropropene;
2-bromo-1,3,3,3-tetrafluoropropene;
1-bromo-2,3,3,3-tetrafluoropropene;
3-bromo-1,1,2-trifluoropropene;
3-bromo-1,3,3-trifluoropropene;
2-bromo-3,3,3-trifluoropropene;
3-bromo-2,3,3-trifluoropropene;
2-bromo-1,3,3-trifluoropropene;
1-bromo-3,3,3-trifluoropropene;
3-bromo-3,4,4,4-tetrafluoro-1-butene;
2-bromo-4,4,4-trifluoro-2-butene;
2-bromo-11,1-trifluoro-2-butene;
1-bromo-3,3,3-trifluoro-2-(trifluoromethyl)-propene;
2-bromo-11,1,3,4,4,4-heptafluoro-2-butene;
2-bromo-3,3,4,4,4-pentafluoro-1-butene;
1-bromo-3,3,4,4,4,-pentafluoro-1-butene;
2-(bromomethyl)-1,1,3,3,3-pentafluoropropene;
2-(bromodifluoromethyl)-3,3,3-trifluoropropene;
4-bromo-3,3,4,4-tetrafluoro-1-butene;
2-bromo-1,1,3,4,4,5,5,5-octafluoro-2-pentene;
2-bromo-1,1,3,4,4,5,5,5-octafluoro-1-pentene;
2-bromo-3,4,4,4-tetrafluoro-3-(trifluoromethyl)-1-butene;
1-bromo-2,3,3,4,4,5,5-heptafluoro-1-pentene;
2-bromo-3,3,4,4,5,5,5-heptafluoro-1-pentene;
1-bromo-4,4,4-trifluoro-3-(trifluoromethyl)-1-butene;
4-bromo-1,1,1-trifluoro-2-(trifluoromethyl)-2-butene;
3-(bromodifluoromethyl)-3,4,4,4-tetrafluoro-1-butene;
5-bromo-1,1,3,3,5,5-hexafluoro-1-pentene; and
3-bromo-1,1,1,2,4,4,5,5,5-nonafluoro-2-pentene;
wherein the flammable refrigerant or heat transfer fluid is selected from the group consisting of fluoroethers, hydrocarbon ethers, and combinations thereof.

18. A method of using a flammable refrigerant in refrigeration apparatus or air-conditioning apparatus, said method comprising combining said flammable refrigerant with the bromofluoro-olefin composition of claim 1, wherein said flammable refrigerant is selected from the group consisting of fluoroethers, hydrocarbon ethers, and combinations thereof.

19. The method of claim 18 wherein said flammable refrigerant is selected from the group consisting of:
C₄F₉OC₂H₅;
dimethylether; and
combinations thereof.

20. A method of claim 17 wherein the bromofluoro-olefin is 4-bromo-3,3,4,4-tetrafluoro-1-butene and the flammable refrigerant is C₄F₉OC₂H₅.

21. A process to produce cooling as in claim 10 further comprising compressing the refrigerant composition in a centrifugal compressor.

22. A process as in claim 10 wherein the bromofluoro-olefin is 4-bromo-3,3,4,4-tetrafluoro-1-butene,

23. A process as in claim 22 wherein the bromofluoro-olefin further comprises C₄F₉OC₂H₅.

24. The method of claim 21, wherein said centrifugal compressor is a multi-stage centrifugal compressor.

25. The method of claim 24, wherein said multi-stage centrifugal compressor is a two-stage centrifugal compressor.

26. A process to produce cooling as in claim 10 wherein the cooling is produced in a refrigeration apparatus or air-conditioning apparatus comprising of at least one single slab/single pass heat exchanger.

27. A process to produce cooling as in claim 21 wherein said centrifugal compressor is a mini-centrifugal compressor powered by an engine exhaust gas driven turbine.

28. A process to produce cooling as in claim 21 wherein said centrifugal compressor is a mini-centrifugal compressor powered by a ratioed gear drive assembly with a ratioed belt drive.

29. A process to produce cooling as in claim 26 further comprising compressing the refrigerant or heat transfer composition in a centrifugal compressor.

30. A process for transfer of heat from a heat source to a heat sink wherein the composition of claim 1 serves as heat transfer fluid, and wherein said process for transfer of heat comprises transporting said composition from a heat source to a heat sink.

31. A method for replacing CFC-113 (1,1,2-trichloro-1,2,2-trifluoroethane) as a refrigerant, said method comprising providing a composition comprising one or more bromofluoro-olefins as the replacement.
